(19) United States
(12) Patent Application Publication
(10) Pub. No.: US 2014/0143419 A1
(43) Pub. Date: May 22, 2014

(54) CONTROL OF NETWORKS

(71) Applicants: Valeriy Vyatkin, Glenfield (NZ); Nirmal-Kumar Chenthamarakshan Nair, Meadowbank (NZ); Chen Wei Yang, Papatoetoe (NZ); Gulnara Aytkazievna Zhabelova, Sandringham (NZ)

(72) Inventors: Valeriy Vyatkin, Glenfield (NZ); Nirmal-Kumar Chenthamarakshan Nair, Meadowbank (NZ); Chen Wei Yang, Papatoetoe (NZ); Gulnara Aytkazievna Zhabelova, Sandringham (NZ)

(73) Assignee: Auckland UniServices, Auckland (NZ)

(21) Appl. No.: 14/233,214

(22) PCT Filed: Jul. 19, 2012
(86) PCT No.: PCT/NZ2012/000126

§ 371 Date: Jan. 16, 2014

Related U.S. Application Data
(60) Provisional application No. 61/509,558, filed on Jul. 19, 2011.

(51) Int. Cl. H04L 12/24

(52) U.S. Cl. CPC H04L 41/50
USPC 709/224

(57) ABSTRACT

The invention provides a network of devices and a set of processors which control and/or monitor these devices by executing code defining a data-model for the network. This data-model incorporates a set of logical-nodes encapsulating network function and/or network devices, and are arranged in a hierarchy for centralised control and/or monitoring. Each logical-node includes a service-module having a set of connections for service-events and can store and/or update service-data objects, with service-events and service-data objects conforming to types defined by a network standard. Each logical-node also includes an intelligence-module having connections to exchange intelligence-events with other intelligence-modules and being operable to participate in intelligence-operations distributed across multiple intelligence-modules, and may generate service-intelligence-data defining service-events for one or more service-modules.

### FIELD OF THE INVENTION

The present invention relates to networks, the control of these and controllers for these. The invention has particular application in respect to networks such as power substation networks and more particularly those centrally automated using the IEC61850 standard. Further in particular, the invention may relate to the detection of the presence and location of faults or potential faults in a power distribution network.

### BACKGROUND OF THE INVENTION

Various industries rely on networks of devices. One challenge for network engineers is ensuring interoperability and coordinated control of devices and network elements. Another challenge is providing robust network protection for events that disrupt services. Standards have evolved for centralised control or automation of network devices and for communication between devices. These generally rely on imposing a limited number of standardised events, data objects and functionality.

There is a continual need for increasingly sophisticated software applications for controlling networks. Applications involving multiple software agents show promise. One reason for this is that they are well suited to applying intelligence that uses data gathered from different networks elements. However, the implementation of these multiple agent applications can be problematic in industries that rely on the interoperability and robust protection provided by standards for centralised control or automation. The limited events, data types and functionality of standards used in these industries do not facilitate sophisticated distributed applications. Conversely, departure from these standards is not feasible in industries which might provide essential services or—with power distribution networks—deal with potentially lethal voltages and currents.

A variety of different types of device networks designed and implemented using standards for centralised control and/or automation are presently restricted by these circumstances.

For example, one type of network which would benefit from applications involving multiple agents but which is constrained by the need for interoperability and robust operation is electrical power distribution networks, or electricity substation networks. The typical electricity customer might be supplied via a service wire from a three-phase, Low Voltage distribution feeder with a nominal voltage of 240 volts (phase-to-neutral)/415 volts (phase-to-phase). Each LV feeder is supplied by an 11 kV/415V distribution substation, typically a pole transformer or ground transformer. Each distribution substation is supplied via a Medium Voltage MV distribution feeder, with a nominal voltage of 11 kV, phase-to-phase, from a zone substation. Each zone substation is supplied via a 33 kV or 110 kV sub-transmission network from a bulk supply substation. Each bulk supply substation constitutes an interface to the transmission system. A distribution substation might manage 300 zone substations. For each zone substation there may typically be 6-12 11 kV feeders, 80-150 distribution substations and 5000-10 000 customers.

After supplying customers with electricity, the foremost mission critical function of the electricity substation network is protection, this is the detection and clearance of faults and overloads. A fault is defined as an uncontrolled flow of electrical energy due to insulation failure. The simplest form of protection is fuse protection, generally used only at extremities of the network. Elsewhere, faults are detected by protective relays and cleared by circuit breakers. A protective relay processes voltage and current measurements in order to determine the existence, and also in some cases the location, of a fault. A circuit breaker is a type of switch capable of interrupting fault current. Other switch types with less onerous capabilities include load break switches, capable of interrupting load current but not fault current, and disconnectors, only capable of off-load switching for the purpose of isolating equipment for maintenance access.

Faults on 11 kV overhead feeders can be temporary in nature, such as caused by tree branches or animals. Accordingly feeder circuit breakers are often configured with automatic reclosing, a function which re-closes the circuit breaker one or more times after fault clearance in an attempt to restore supply. If the fault is permanent, a lockout occurs and the feeder cannot be put back into service until repaired.

To speed the process of restoring customers blacked out by a fault, an 11 kV feeder may be divided into sections by sectionalising switches, and connected to adjacent feeders via tie switches. Once a fault has been located, sectionalizing switches are opened to isolate the faulted section, and tie switches are closed to restore supply to the unfaulted sections. Computer-based remote control of power system equipment simplifies such processes as restoring power to customers blacked out by a fault. For example, control of sectionalising switches can be done by remote manual control using a Supervisory Control And Data Acquisition (SCADA) system. SCADA is a commonly a feature of zone substations. With improvements in technology, SCADA has become cost effective for distribution system equipment as well. Recently, automated Fault Location, Isolation and Supply Restoration (FLISR) products have begun to appear on the market. These products use the SCADA system as eyes and arms to gather information about faults and execute the necessary control actions, such as the opening and closing of switches.

The IEC 61850 standard introduces various elements of a power system-related automation architecture called Substation Automation System (SAS). According to the IEC 61850, a SAS can be represented in a 3-layered form which facilitates centralized monitoring and automation or control of the network.

The IEC61850 standard also provides a data model involving logical nodes, which are capsules of data, such as Pos, and functionality, such as position indication of a circuit breaker. The functionality of the substation network can be modeled as a collection logical nodes.

A limitation of the IEC61850 standard is that it does not cover the representation of control and automation logic. This limitation of the

The applicant has observed that the IEC 61499 standard can be used to define applications for a wide range of control and automation logic. The IEC 61499 standard describes a general purpose Function Block (FB) architecture for industrial measurement and control systems. A FB is a software unit that encapsulates some behavior. IEC 61499 defines three classes of FBs: basic FBs, composite FBs, and service interface FBs. Each FB has a set of input and output variables. Input variables are read by an internal algorithm when it is executed, while the results from the algorithm are written to the outputs.

In IEC 61499 basic FBs have a state machine which defines the response of the block to input events. The state machine is called an Execution Control Chart (ECC). The response can consist of the execution of algorithms, computing output variables and internal variables as functions of input variables and internal variables, and the generation of one or several output events.

A composite FB encapsulates a network of FBs, both basic and composite, connected to the external data and event sources. The possibility to include composite FBs within other composite FBs enables a hierarchical system description. This is useful for defining multilayered architectures. FB-based architecture also enables modeling and simulation to be tightly integrated with the design process. Before deployment, the controller can be validated by either simulation or formal verification. In the IEC 61499 architecture, the function performed by the system is specified as an application, which may reside in a single device or be distributed among several devices. The application consists of a network of FBs connected by data connections and event connections. The control system is specified as a collection of devices interconnected and communicating with each other by means of one or more communication networks.

The use of FBs makes the control device openly programmable and easily reconfigurable. IEC 61499-compliant devices can easily interface with each other, thus providing for seamless distribution of different tasks across different devices. The user may create their own program using standard FB types. Thus, the IEC61499 architecture enables encapsulation, portability, interoperability, and configurability. Portability means that software tools and hardware devices can accept and correctly interpret software components and system configurations produced by other software tools. With interoperability, hardware devices can operate together to perform the cooperative functions specified by one or more distributed applications. With configurability, devices and their software components can be configured (selected, assigned locations, interconnected, and parameterized) by multiple software tools.

A limitation of the IEC 61499 is that it does not ensure interoperability and robust control of networks. For example, the IEC61499 does not provide an architecture for encapsulating network functions and data or standardized communications between such capsules.

### DISCLOSURE OF THE INVENTION

According to one aspect of the invention there is provided a network including a set of network devices and a set of processors operable to control and/or monitor the operation of the set of devices by executing code defining a data-model for the network, the data-model comprising a set of logical-nodes encapsulating network functions and/or network devices, wherein the data-model is structured in a hierarchy for centralised control and/or monitoring, wherein for each logical-node the code defines:
at least one service-module having a set of connections for service-events and operable to store and/or update service-data objects in response to service-events, wherein the service-events and service-data objects conform to types defined for the logical-node by a standard;
at least one intelligence-module having connections to exchange intelligence-events with other intelligence-modules and operable to participate in intelligence-operations distributed across multiple intelligence-modules and operable to generate service-intelligence data defining service-events for one or more service-modules,
   whereby service-events are used to control and/or monitor the operation of the set of devices and whereby one or more of the service-events are defined by intelligence-operations

According to a further aspect of the invention there is provided a network of devices including a set of processors operable to execute control code to control the devices, the code comprising a set of node-modules each encapsulating a node of a data-model defined for the network, each node-module comprising:
at least one service-module having connections to exchange service-events and service-data objects with other node-modules, the service-events and service-data objects conforming to a standard, the service-module having one or more algorithms to store and/or update data for the node-module dependent on service-events and dependent on service-data objects received at the connections;
at least one intelligence-module having connections to exchange intelligence-events and intelligence-data objects with other intelligence-modules, having one or more algorithms to participate in intelligence-operations distributed across a number of intelligence-modules, and one or more algorithms to generate service-intelligence data defining service-events and service-data;
at least one interpreter having connections to receive service-intelligence data and generate service-events and service-data objects which conform to the standard.

According to another aspect of the invention there is provided a carrier medium carrying code defining a code module which encapsulates a node-module of a data-model defined for a network, the code module comprises:
a service-module arranged to make a set of connections to exchange service-events and service-data objects with other node-modules, the service-events and service-data objects conforming to a network standard, the node-module having one or more algorithms to store and/or update data for the node-module dependent on service-events and service-data objects received at the connections;
an intelligence-module arranged to make to connections exchange intelligence-events and intelligence-data objects with other intelligence modules, said intelligence-module having one or more algorithms to participate in intelligence-operations distributed across a number of intelligence modules, and one or more algorithms to generate service-intelligence data defining service-events and service-data;
   whereby service-events are used to control and/or monitor the operation of the set of devices and whereby one or more of the service-events are defined by intelligence-operations.

According to yet a further aspect of the invention there is provided a processor with data memory and operating memory, said data memory storing a code module which encapsulates a node-module of a data-model defined for a network, the code module comprises:
at least one service-module configured to make connections for the communication of service-events and operable to store and/or update service-data objects in response to service-events, wherein the service-events and service-data objects conform to types defined for the logical-node by a standard;
at least one intelligence-module configured to make connections to exchange intelligence-events with other intelligence-modules and to operable to participate in intelligence-operations distributed across multiple intelligence-modules and operable to generate service-intelligence data defining service-events for one or more service-modules,

According to another aspect of the invention there is provided an integrated development environment arranged to assemble a code module which encapsulates a node-module of a data-model defined for a network, where the code module comprises:
at least one service-module configured to make connections for the communication of service-events and operable to store and/or update service-data objects in response to service-events, wherein the service-events and service-data objects conform to types defined for the logical-node by a design standard;
at least one intelligence-module configured to make connections to exchange intelligence-events with other intelligence-modules and to operable to participate in intelligence-operations distributed across multiple intelligence-modules and operable to generate service-intelligence data defining service-events for one or more service-modules;
at least one interpreter having configured to make connections to receive service-intelligence data and generate service-events and service-data objects which conform to the standard,
   said integrated development environment including a library of code elements available for selection by a user for assembly into a code module.

According to yet a further aspect of the invention there is provided a network including a set of network devices and a set of processors operable to control and/or monitor the operation of the set of devices by executing code defining a data-model for the network, the data-model comprising a set of logical-nodes encapsulating network functions and/or network devices, the data-model being composed of logical-nodes of defined types conforming to a design standard, the design standard defining allowed interconnections of logical-nodes for centralised monitoring and/or control of the set of devices, wherein the data-model is structured in a hierarchy for centralised control and/or monitoring, wherein for each logical-node the code defines:
at least one service-module having a set of connections for service-events and operable to store and/or update service-data objects in response to service-events, the service-module having a dedicated connection for each type of service-event to be received by the service-module, wherein the service-events and service-data objects conform to types defined for the logical-node by the design standard, the design standard defining the type of service-events which the service-module is allowed to receive;
at least one intelligence-module having connections to exchange intelligence-events with other intelligence-modules and operable to participate in intelligence-operations distributed across multiple intelligence-modules and operable to generate service-intelligence data defining service-events capable of reception by the service-module or service-modules of the type or types defined for the logical-node by the design standard,
   whereby service-events are used to control and/or monitor the operation of the set of devices and whereby one or more of the service-events are defined by intelligence-operations.

According to yet another aspect of the invention there is provided a network substantially as described above wherein the design standard defines a multi-layer data-model with interconnected layers for physical functions, network protection for physical functions, and central automation and human interfacing, whereby a central controller and human interface are adapted to assert control over the network, and said at least one intelligence module implements an agent of a multi-agent distributed intelligence application to participate in intelligence-operations to influence control of the network.

Preferably in this aspect of the invention each logical-node the code defines an interpreter-module having one or more connections for the communication of service-intelligence data and for service-events, each interpreter-module being operable to parse service-intelligence data to service-events.

Reference is made within this specification to the invention incorporating, implementing, providing or otherwise exhibiting features, functions or characteristics defined by a standard or a number of standards. Those skilled in the art will appreciate that these functions or components of the invention should be understood to be provided in compliance with the requirements of such a standard or standards, or potentially are implemented as outlined, described or dictated by a standard or standards.

Preferably the present invention may use design standards to dictate the formulation or construction of a data model of a network and/or the components which make up such a data model of a network. A design standard should be understood by the skilled reader as providing a fixed description, specification or rule set for the design and/or operation of a network and its components.

In some embodiments a standard associated with or for a form of network defines a design architecture, such as, for example a hierarchy of devices and nodes arranged to provide centralised control. For example a design standard provided by IEC61850 details the provision of a Substation Automation System (SAS) represented in a 3-layered form which facilitates centralized monitoring and automation or control of the substation network.

In some embodiments a design standard may define a set of event types and corresponding data types and services to cause given logical nodes perform given network functions. Service-events, data objects, services and functions may be associated according to a given type of logical node.

In a preferred embodiment the design standard employed with the invention may define allowed interconnections of logical-nodes to centralise monitoring and/or control of the set of devices present within the network. In such embodiments the design standard may also dictate that service-modules have a dedicated connection for each type of service-event to be received by the service model, in addition to dictating the types of service-events which a service-module is allowed to receive. This form of design standard restricts the specifics of the design which can be used to implement each logical-node, thereby making monitoring and control of the network a more predictable and easier task.

In a further preferred embodiment a logical-nodes intelligence-module or modules may also be operable to generate service-intelligence data defining the service-events which are capable of reception by the service-module or modules of the type or types defined for the logical-node by the design standard used. In such embodiments this arrangement of intelligence-modules provides the ability for distributed intelligence-operations executed across multiple intelligence-modules to influence control of the network. An intelligence-module resident with in each logical-node is provided with the capacity to supply service-events to a service-module within the same logical-node, where intelligence-operations will be used to determine if and when such service-events should be supplied.

In a preferred embodiment the design standard used by the invention may define a multi-layered data-model. In such an embodiment this data-model may define interconnected layers for physical functions, network protection for physical functions, and central automation and human interfacing. Such a multi-layered data-model may allow a central controller and human interface to assert control over the network being modelled.

In a further preferred embodiment such a multi-layered data model may also incorporate logical-nodes which define an intelligence-module implementing an agent of a multi-agent distributed intelligence application. Such a multi-agent distributed intelligence application can allow distributed intelligence-operations to be completed to influence control of the network.

In addition to a design or design standards the present invention may also use one or more intelligence standards in the formulation of a data-model. For example such intelligence standards may be used to extend the functionality provided by a design standard or potentially increase the operational flexibility of the network involved. For example in some embodiments intelligence standards such as IEC61499 or IEC61131 may be used in the formulation of a data model.

Reference is also made within this specification to the invention providing a network incorporating network devices which may in some instances perform or execute network services. Again those skilled in the art will appreciate that these forms of networks, the network devices provided within them and the network services performed will be dictated by the particular application in which the invention is used. References to networks, network devices and/or network services should in no way be construed as limiting the invention to use in data transmission or information technology networks in isolation.

A data-model utilised in conjunction with the invention comprises a set of logical-nodes encapsulating network functions and/or network devices. Those skilled in the art will appreciate that the network devices represented in the data model may be the actual devices present in the network being modelled. Furthermore, the network functions encapsulated by the logical notes of the data model may representative of any operation, facility and/or service completed by or in association with the network devices and/or the network modelled.

References throughout this specification to modules implemented or provided in conjunction with the invention should be interpreted to encompass any form of module discussed in respect of the invention—such as, for example, service-modules, intelligence-modules and/or interpreter-modules.

A logical node includes at least one intelligence-module, control module, or controller which provides intelligence for the behaviour of the logical node represented by the module. The intelligence-module has code to implement algorithms which may or may not conform to the standard used by the service interface module.

Preferably the devices in the network are connected so as to provide centralised monitoring and/or control of the network. In a further preferred embodiment the devices are connected in a hierarchy.

Preferably the data-model includes groups of logic-nodes structured to form a logical device as defined by a standard.

Preferably each processor is associated with a device and operable to control the associated device dependent on data stored by a service-module.

Preferably a device may be a logical device as defined by a standard or a physical device.

Preferably the data-model is defined by a standard. In a further preferred embodiment the standard is IEC61850.

Preferably modules are provided by IEC61499 or IEC61131 standard compliant function blocks.

Preferably the code defining each logical-node or module includes an event driven algorithm and a scheduler.

Preferably one or more modules is a composite module formed from other modules.

Preferably the network is a power distribution network. In a further preferred embodiment the network is a power distribution substation

Preferably intelligence-operations include protection and/or monitoring processes for the network.

Preferably an intelligence-module implements an agent of a multi-agent distributed intelligence application to participate in intelligence-operations.

Preferably intelligence-operations include bartering algorithms involving bartering between agents associated with two or more logical nodes or two or more logical devices

An intelligence-module is arranged to exchange intelligence-events and intelligence data objects with other intelligence-modules. These intelligence-events and intelligence data objects allow for the control of the network when utilised by intelligence-operations which are executed in a distributed architecture across number of intelligence-modules. Intelligence algorithms run in conjunction with each intelligence-module allow an intelligence-module to participate in such distributed intelligence-operations.

Intelligence-modules generate service-intelligence-data which can be provided to service interface modules to define and provide standards compliant service-events and service-data objects. These standards compliant service-events and-service-data objects can differ from the intelligence-events and intelligence data objects communicated between intelligence-modules which need not be standards compliant. The skilled reader will appreciate that these intelligence-events and intelligence data objects may utilise any desired arrangement of a data structure, function or data organisation scheme which allows intelligence-modules to generate service-intelligence-data which can effectively control the network involved.

In a preferred embodiment a user may define arbitrary code for the intelligence-module, for the behaviour of logical nodes, independently of any code defined for the service interface module, for interoperable communication between logical nodes. In such instance the service-interface module can interface with other logical nodes using service-events and service-data objects that conform to the standard used by the logical node and performs operations which conform to services defined by the standard. Therefore, the service interface module can provide for standardised communication and assured interoperability of logical nodes according to the standard, irrespective of any code or operations implemented by the intelligence-module. The intelligence-modules of this embodiment may be recognised as user-defined because a user can define code independently of the standard defining communication and services.

One additional aspect of the present invention provides a network controlled using a data model which represents the network logically as a set of nodes each representing a network function or network device and controlled by executing a set of node-modules which are each operable to store data for a corresponding node and which are each able to communicate with other node-modules for the control of the network, wherein each node-module includes:
a data-module having one or more service connections for communication with other data-modules to perform services defined for the network, wherein the service-connections are suitable for service-events defined for the network and data-types defined for the network to ensure interoperable communication between node-modules, and
a behaviour-module with intelligence-connections for communicating with behaviour-modules of other node-modules to participate in distributed algorithms to determine behaviour for the network.

The data model may be adapted to facilitate the determination of faults and/or the location of faults in the network. The data model may be adapted to facilitate centralised automation for protection in response to faults in the network. The data model may be adapted for centralised monitoring of data describing faults on the network.

The behaviour may be for one or more network devices.

The node-modules may include blocks which are able to participate in the exchange of events and able to perform event-driven operations. The standardised events and data-types may be standardised according to the IEC61850 standard. The blocks may be function-blocks as defined by one of the IEC61499 and IEC61131 standards. The node-modules may comprise connections between the data-module and the behaviour-module. The controller-module may include an interpreter-module able to interpret data or events from the behaviour-module into standardised events.

A further aspect of the invention provides a network including a set of logical nodes as defined by the IEC61850 standard, the network executing one or more function blocks of software, each function block including a network of event-driven capsules each operable to exchange events with other event-driven capsules. The event-driven capsules may conform to a reference architecture for distributed software systems.

One aspect of the present invention provides a network of physical devices each controlled by one or more logical node software-modules, the software-modules grouped according to a standardised data model as logical-devices, wherein a logical device is logical analog to a physical device, each logical node communicating using standardised events and standardised data-types, wherein a logical node software-module includes code which when executed:
stores data for the standardised data model using the standardised data types; and
implements a controller for agent-based control of physical devices.

A logical node-software-module may be able to perform one or more operations so as to implement standardised services.

The network of physical devices may be provided as components of a power distribution network, each physical devices being controlled by a group of logical node software-modules grouped according to a standardised network model as logical devices. For example in a preferred embodiment where the invention employs IEC 61850 as the design standard to be used, a logical device may be provided equivalent to the description of IEC61850. Such logical devices may be used to represent the characteristics or functions of a physical device or a subset of characteristics or functions of a physical device.

The software module may include a connection between the controller and the database for service requests.

One aspect of the present invention provides a network of devices controlled using data stored by a group of logical nodes such as defined by the IEC61850 standard, the network including a logical node-code-module associated with each logical node and including one or more processors operable to execute the logical node code-modules to control the devices, wherein each logical node code-module includes:
a service-module operable to perform one or more operations in response to events selected from a set of service-events defined by the IEC61850 standard and operable to store data using a set of data types defined by the IEC61850 standard; and
an intelligence-module including code to exchange events with other intelligence-modules and code to perform algorithms to participate with other intelligence-modules in distributed operations to determine behaviour for one or more logical nodes and thereby determine behaviour for one or more devices.

The logical node code-module may include one or more service-connections between the service-module and the intelligence-module, the one or more service-connections being operable to communicate data identifying a service as defined by the IEC61859 standard to allow the intelligence-module to control the logical node by identifying services.

The logical node code may be implemented using event-driven code-blocks each including an event-driven algorithm and each including one or more connections for events. The one or more event-driven code-blocks may include one or more schedulers operable to schedule the algorithm as part of a distributed operation. The one or more event-driven code-blocks may be function-blocks such as defined by one of the IEC61499 and IEC61131 standards.

The service-module may be operable to store data defining the logical node with which the code-module is associated. The data stored may define the state of a logical node forming part of a logical device which is a logical analog to a network device. Therefore, a group of logical nodes may be able to store data representing the state of a device. The service-module may include code defining one or more algorithms operable to respond to the set of events to perform operations such as defined for services of the IEC61850 standard. The operations may include any one or more of: receiving data, storing data, updating stored data, sending stored data, and generating events for given logical nodes.

The service-module may include a data-module connected to the service-interpreter-module by a set of service-event connections. The data-module may include data-connections for receiving data objects to store. The intelligence-module may include data-connections to communicate data-objects to the data-module.

The service-module may include a service-interpreter-module operable to parse service-request-strings received in a string-data-type into service-events. The service-interpreter-module and data-module may have corresponding sets of event-connections for communication events. The sets of event-connections may be defined by a standard for the network. The corresponding sets of event connections may be defined by the service requests of the IEC61850 standard.

The data-module may include an event connection for each service defined for the network. Services defined for the network may be defined by the IEC61850 standard.

The data-module may include code defining algorithms to send service-events in response to service-events received at the event connections. The data-module may comprise code defining algorithms to perform one or more of updating, sending and receiving data in response to events received at the event connections. The data-module may include a database.

The network may comprise logical nodes associated with node-locations representing locations associated with logical nodes and the network may include processors at the node-locations to execute the logical node code associated with the respective node-location.

The intelligence-module may implement one or more function-blocks. The service-module may include one or more function-blocks. The logical node code may be implemented entirely using function-blocks. A function-block may be event-driven. A function-block may be operable to exchange events. A function-block may comply with a distributed system architecture. One or more of the event-driven, event exchange or distributed architecture functionality may be as defined in the IEC61499 or IEC61131 standards.

One aspect of the present invention provides a method of controlling a network of devices communicating using service-request-events and data-objects defined by the IEC61850 standard, the method including:
compiling logical nodes for the devices,
receiving and transmitting service-request-events and data-objects for each logical node at service-interface-modules, each service-interface-module including one or more connections for one or more service-request events and for data-objects of the IEC61850 standard;
performing services for each logical node dependent on the service-request-events and data objects received for each logical node;
receiving and/or sending events for each logical node at intelligence-modules; and
performing in the intelligence-modules one or more event-driven processes for each logical node to implement distributed intelligence for the behaviour of the devices.

One aspect of the present invention provides a set of processors distributed across a power substation network to control logical nodes of the substation network, wherein a logical node is defined according to the IEC61850 standard, and wherein each processor executes a logical node-code-module which includes:
a service-module operable to perform one or more services in response to receiving one or more service-requests and one or more data-objects, the services, service-requests and data-objects being defined according to the IEC61850 standard; and
an intelligence-module operable in combination with the intelligence-modules of logical node code executed by other processors to perform distributed event-driven operations to determine the behaviour of the logical nodes.

The logical node code-module may include a connection between the intelligence-module and the service-module to allow the intelligence-module to identify service-requests defined by the IEC61850 standard.

Each processor may implement a service-interpreter-module operable to parse data from the intelligence-module into event types defined by the IEC61850 standard, wherein the data identifies service-requests.

The processors may execute code which is defined by one or more of the IEC61499 or IEC61131 standards.

One aspect of the present invention provides a device controller in a network using communications between a set of logical nodes as defined by a data model of the IEC61850 standard, the device controller including:
a service-interface including one or more service-connections for service-request events and data objects defined by the IEC61850 standard to communicate with other processors using the IEC61850 standard; and
a behaviour controller including one or more connections for intelligence-events and including code defining one or more event-driven processes.

The behaviour controller may be operable to generate service-request data identifying IEC61850 compliant service-requests.

The service-interface may include a connection for receiving service-request-string data of a string data-type to respond to service-events determined by the intelligence-module.

The service-interface-module may include a data-module operable to perform processes representing services defined by the IEC61850 standard in response to service-request events.

The service-interface may include a service-interpreter-module including one or more connections operable to receive service-request-string in a string data-type data from the intelligence-module, and including event connections operable to provide service-request-events for the data-module, the service-interpreter-module operable to parse service-request-string data into service-request-events.

The service-interface-module may include a data-module operable to perform processes representing services defined by the IEC61850 standard dependent on service-request-events and data-objects. The data-module may be operable to store data using hierarchies of data-types defined for the network. The data-module may be operable to store data using data-types defined by the IEC61850 standard. The data-module may include event connections for events defined by service-requests and data-connections for data objects.

One aspect of the present invention provides a network of devices modelled as logical nodes which logically perform one or more network functions, the network including a logical node code-module associated with each logical node and including one or more processors operable to execute the logical node code-modules, wherein each logical node code-module includes:
a service-module responsive to a set of events defined according to a network standard and operable to store data using a set of data-types defined for the network, wherein the service-module is able to communicate with service-modules of other logical node code-modules using the network standard; and
an intelligence-module including one or more intelligence-event connections for events from intelligence-modules of other logical node code-modules and one or more event-driven algorithms to perform distributed operations in combination with intelligence-modules of other logical node code-modules to determine the behaviour of the logical nodes, whereby logical nodes communicating using the network standard are controlled according to intelligence determined by operations involving multiple logical nodes.

One aspect of the present invention provides a processor operable to control devices in a network using communications between logical nodes operable to perform a one or more defined network functions, the processor executing logical node code including:
a service-interface-module including connections for service-requests and including connections for data-objects of data types standardised for the network to perform the one or more network functions, wherein the service-events and data objects conform to a set of event-types and data-types defined for the network;
an intelligence-module including one or more connections for receiving signals from intelligence-modules of other processors and intelligence code to implement one or more algorithms to participate in operations involving the intelligence-modules of multiple processors.

The network may include a heterogeneous set of devices.

The devices may be devices in an electricity substation network.

One aspect of the present invention provides an electricity substation network including devices operable to collectively perform network functions and including controllers operable to control the behaviour of groups of devices, the devices grouped logically such that a group is able to perform one or more network functions by communicating using a set of event types standardised for the network and a set of data types standardised for the network, the code including:
a service-interface including one or more connections for the standardised events and including connections for data-objects of the standardised data-types and operable to perform one or more network functions;
an intelligence-module including one or more connections for receiving events and code to implement one or more event-driven algorithms whereby the intelligence-modules are each operable to perform event-driven algorithms and operable to exchange events to participate in multi-agent control of the behaviour of the groups of devices.

In one further aspect the invention provides an automated electrical power distribution network including a set of devices operable to distribute power from a bulk supply substation to multiple end-user sites, to perform protection operations for the network and to perform monitoring of the network, the devices connected in a hierarchy so as to provide centralised monitoring and/or control of the devices, the network comprising a set of processors operable to control the devices, the processors also operable to execute code defining a set of logical nodes providing an information model of the network and performing service-algorithms to update stored control-data used the by processors to control the devices, wherein code defining each logical node comprises a set of function blocks, and wherein the set of function blocks comprises:
a data-block including code defining connections for service-events and connections for data-objects, and including code to perform one or more service-algorithms in response to service-events and including code to update stored control-data in response to the service-algorithms, wherein the events, data objects and services-algorithms conform to a set defined by a standard,
an intelligence-block including code to exchange events with other intelligence blocks and to perform operations to participate in distributed intelligence for control of the network and including code to generate event-data, the event-data identifying events for the data-block; and
an interpreter-block including code defining connections for the event-data from the intelligence block and defining connection for the events for the data-block and defining code to generate events for the data block corresponding to the events identified by the event-data.

Each function block may comprise one or more algorithms and one or more state machines operable to control the execution of the one or more algorithms.

The data block may update data using data-types defined by the standard.

The data block may be operable to update data and perform corresponding services so as to encapsulate the data and service or services.

In a further aspect of the invention an integrated development environment or IDE is provided. An IDE can facilitate the formulation and assembly of the code modules which implement a data model defined for a network.

In embodiments where an IDE is provided the IDE may also incorporate or have access to a library of code elements. These code elements may be reviewed by a user who can make selections from the library during the design of a particular code module to be provided for the data model of a specific network.

Aspects of the present invention provide a computer readable carrier or medium bearing code which if executed causes the computer, or processor, to perform processes or methods or to configure the computer operate according to any of the paragraphs above.

Aspects of the present invention provide a computer having a processor, program memory and data memory, the data memory storing code which if executed causes the or processor to perform processes or methods or to configure the computer operate according to any of the paragraphs above.

Aspects of the present invention provide control of a network using an object-oriented code modules each encapsulating a network function or device wherein the code module is implemented using event-driven code-blocks which include event-driven algorithms and connections to exchange events with other code-blocks. The event-driven code-blocks may be functional-blocks as defined by the IEC61499 or IEC61131 standards.

Aspects of the present invention provide control of a network using an object-oriented code-module encapsulating a network function or device wherein the code module includes one or more code-blocks which participate in intelligence applications involving other object-oriented code modules.

Aspects of the invention may provide control of a network of network devices the network being operable to perform network functions, the control using code modules which encapsulate network functions and/or network devices and associated data, wherein the code modules include a database encapsulating nodes of an information model as defined by a standard and implementing communication with other nodes according to a standard for centralised automation of the network, and wherein the code modules include one or more function blocks implementing the network functions.

Aspects of the present invention provide control of a network using an object-oriented code-module encapsulating a network function or device wherein the code module includes a service-module operable to perform operations to implement a defined network service in response and operable to communicate using standardised data types defined for the network function and includes an intelligence-module for the implementation of intelligence for behavior of the data module. The intelligence-module may be operable to communicate using data types additional to the standardised data types. The service-module may be responsive to defined service-request-events.

Aspects of the present invention provide control of a network using object oriented code-modules each encapsulating a function or device of a network wherein the code module includes a data module operable to perform operations to implement the network function and operable to communicate using data types defined for the network function and an includes an intelligence-module for the implementation of intelligence for behavior of the data module, and a service interpreter operable to interpret signals from the intelligence-module for the data module.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1 illustrates a substation network with physical devices represented as logical devices and logical nodes;

FIG. 2 illustrates a logical node of a network according to a preferred embodiment of the present invention;

FIG. 3 illustrates a logical node according to an alternative embodiment and shows connections for the logical node and functional blocks used to implement the logical node;

FIG. 4 illustrates a service interpreter module according to the embodiment of FIG. 2;

FIG. 5 illustrates a database module according to the embodiment of FIGS. 2 and 4;

FIG. 6 illustrates an intelligence-module according to the embodiment of FIGS. 2, 4 and 5;

FIG. 7 illustrates data and event flows for a logical node according to the embodiment of FIGS. 2, 4, 5 and 6;

FIG. 8 illustrates a logical node implemented according to an alternative embodiment to FIG. 2;

FIG. 9 illustrates a user defined data type according to a preferred embodiment of the present invention;

FIG. 10 illustrates another user defined data type according to a preferred embodiment of the present invention;

FIG. 11 illustrates a further user defined data type according to a preferred embodiment of the present invention;

FIG. 12 illustrates implementation, using software tools, of a logical node according to a preferred embodiment of the present invention;

FIG. 12a illustrates an example user defined type implementation of a Common Data Class (CDC) according to a preferred embodiment of the present invention;

FIG. 12b illustrates function blocks implementing a Common Data Class according to a preferred embodiment of the present invention;

FIG. 12c illustrates function blocks implementing a database module according to a preferred embodiment of the present invention;

FIG. 13 illustrates an example function block using software tools;

FIG. 14 illustrates operation of a substation network according to a preferred embodiment of the present invention;

FIG. 14a also illustrates operation of a substation network according to a preferred embodiment of the present invention;

FIG. 15 illustrates an example function block implementation and corresponding state-machine of the service-interpreter-module of FIG. 4;

FIG. 16 illustrates an example function block implementation and corresponding state-machine of the database-module of FIG. 5;

FIG. 17 illustrates an example functional block implementation and corresponding state-machine of the intelligence-module of FIG. 6;

FIG. 18 illustrates an alternative example function block implementation, to that of FIG. 17, of an intelligence-module of FIG. 6;

FIG. 19 illustrates a function block implementation of an example logical node.

Further aspects of the invention will become apparent from the following description of the invention which is given by way of example only of particular embodiments.

### BEST MODES FOR CARRYING OUT THE INVENTION

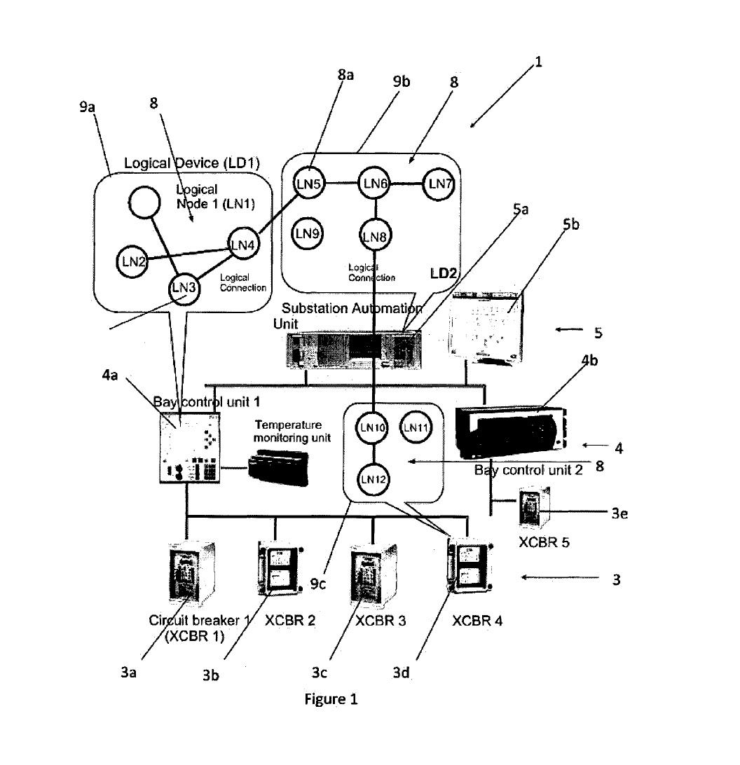

Data modelling of a network of devices according to IEC61850 is depicted in FIG. 1. The network 1 is represented in the form of a hierarchy with 3-layers 3, 4 and 5, in this example. The lowest, physical, layer 3 is implemented with intelligent end devices such as circuit breakers 3a to 3e, remotely operated switches (not shown), current and voltage sensors (not shown) and condition monitoring units for switchgear (not shown), transformers (not shown) and other devices known to the reader.

The devices of the physical layer 3, such as circuit breakers, are connected via communication channels to protective relays (not shown) and bay controllers 4a and 4b of a second layer 4. The devices 4a and 4b in the second layer implement network functions such as protection, monitoring, control and automation tasks in a particular responsibility area, or area of operation. This area might be known to the reader as a bay. The top level 5 of the hierarchy has a substation automation unit 5a, which i) integrates and controls several bays within a substation ii) implements a human-machine interface 5b and iii) communicates with a control centre (not shown). The reader will recognise that the top level implements centralised control and automation of the network.

A set of Logical Nodes (LN) 8 each encapsulate data, such as Pos and network functionality, such as providing in response to a request data describing the circuit breaker position. The IEC61850 standard describes the interdependencies between the logical nodes 8 within devices and across the network. The functionality of a substation network can be modelled as a collection of logical nodes 8 or as a collection of logical devices 9 populated by logical nodes 8. These nodes affect a set of network functions.

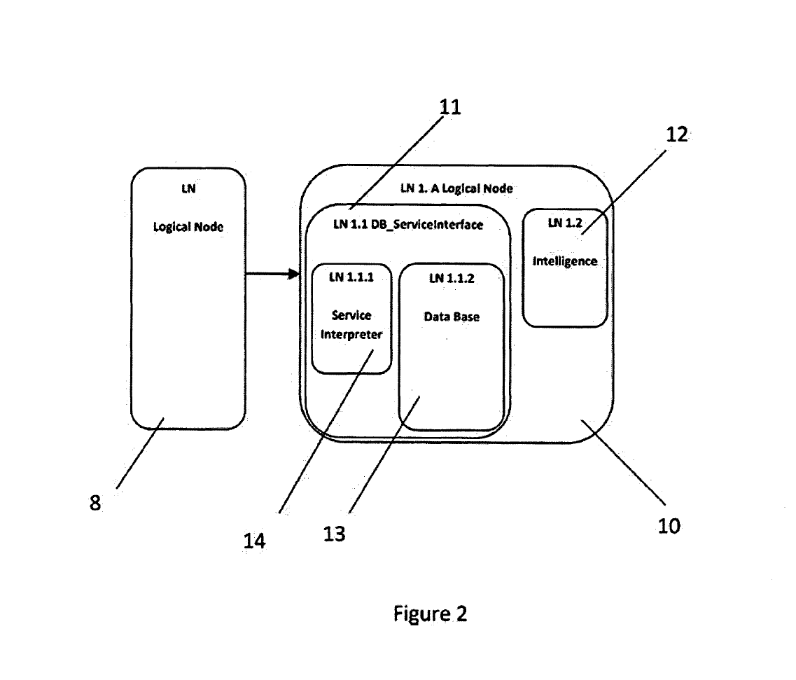

FIG. 2 shows an implementation of a logical node 8 in accordance with an embodiment of the present invention. The logical node 8 in this embodiment is implemented as a software module 10. In this embodiment the logical node module 10 is implemented on a processor (not shown) of an Intelligent Electronic Device (IED) (not shown) forming part of a network to be controlled using the logical node-modules 10. The IED is provisioned to support given logical nodes 8 defined by a design standard standard. For example a circuit breaker physical device may support two logical nodes (not shown) for both a circuit breaker and data describing the circuit breaker position.

The logical node module 10 represents a data and function capsule which stores data representing the state of the logical node and performs functions representing the function encapsulated with the data. The logical node module 10 also communicates and responds to other logical node modules using a set of standardised data objects and events. The standardised data objects represent real-world communication signals within or between parts of a physical device. The logical node module 10 performs functions, dependent on receiving events and data in the form of objects. As known to the reader the functions are manifest as updating data or generating data objects to be communicated to another logical node code module 10. In the case of this embodiment the data objects and services are defined by the IEC61850 standard. Events in the form of requests for services or service requests and may be accompanied by corresponding data objects. For example a logical node 8 representing a circuit breaker position description will generate a Pos data-object in response to receiving a corresponding service-request. The IEC standard defines a list of services which intelligence within a logical node can use to implement a given function. An example of such a function is the overcurrent function, encapsulated by an PIOC LN, which can use an operate service to indicate to a protection trip conditioning function encapsulated by PTRC LN to indicate that a fault has been detected. Therefore, services are used for communications between logical nodes 8 which encapsulate functions.

The logical node module 10 has a service-module 11, database-service-interface or service-interface, which interfaces with other logical nodes 8 communicating using service-event and data objects defined by the standard. The service-interface-module 11 encapsulates data stored to define the logical node 8 of the data model used for the network (not shown) and functionality for the logical node. In this embodiment the data is stored according to data types defined by the IEC61850 standard and the functionality is defined by services of the IEC61850 standard. The service-module 11 receives or exchanges events and data objects defined by the standard and stores data in the standardised data types. These event and data objects may be described as service-events and service-data objects respectively. The service-interface module 11 has code defining algorithms to perform operations representing the services. In this embodiment the algorithms are defined according to the IEC61850 standard.

The logical node 8 also has an intelligence-module 12, control module, or controller which provides intelligence for the behaviour of the logical node represented by the module 10. The intelligence-module 12 of this embodiment has code to implement algorithms which may or may not conform to the standard used by the service interface module 11.

An integrated development environment (IDE) is provided according to this embodiment which allows a user to program arbitrary intelligence functionality which is compiled into an intelligence module 12, which in turn is compiled into a logical node module 8 along with a service module 11. This arrangement and the IDE provided by the invention means that the services and functions of the logical node 8 are ensured to be interoperable, robust and centralised, while at the same time the logical node can be influenced by intelligence functionality.

A user may define arbitrary code for the intelligence-module 12, for the behaviour of logical nodes 8, independently of any code defined for the service interface module 11, for interoperable communication between logical nodes. The service-interface module 11 interfaces with other logical nodes 8 using events and data objects that conform to the standard used by the logical node and performs operations which conform to services defined by the standard. Therefore, the service interface module 11 provides for standardised communication and assured interoperability of logical nodes 8 according to the standard, irrespective of any code or operations implemented by the intelligence-module 12. The intelligence-modules of this embodiment may be recognised as user-defined because a user can define code independently of the standard defining communication and services.

In this embodiment the intelligence-module 12 participates in distributed intelligence for the behaviour or control of logical nodes 8. The reader will recognise the intelligence-module 12 as forming part of a distributed intelligence application with the intelligence-modules of other logical nodes 8. The operations completed by this distributed intelligence application can be described as intelligence-operations. The distributed intelligence application of this embodiment is a multiple agent application distributed over a network (not shown) and is able to gather data from logical nodes 8 at different parts of the network and perform intelligence-operations to coordinate the network. The distributed application also defines service events for the service module 11 so some of the control of the network is dependent on intelligence functionality provided by intelligence-modules 12.

The service interface module 11 of this embodiment has a database 13, or data-module, which provides the standard specific encapsulation of data and services to represent the logical nodes 8 and a service interpreter 14, service interpreter or interpreter-module, to interpret communications, or signals, from the intelligence-module 12. In this embodiment the service interpreter module interfaces with intelligence-module 12 and other logical nodes (not shown), via the intelligence-modules of those other logical nodes 8. In this embodiment also the service-interpreter parses data in a string data type into events which conform to the standard. This allows the intelligence-module 12 to interact with a database which conforms to the standard and thereby ensures interoperability of logical nodes 8 and physical devices (not shown) controlled using the logical nodes 8. In some examples with given embodiments, communication between intelligence and service-interpreter modules within a logical node 8 or 10, need not necessarily comply with the standard, because the communication is within a logical node and the standard is conformed to between logical nodes 8.

The communication between the intelligence-module 12, the service-interpreter-module 14 and the database module 13 is defined by algorithms defined in code for the intelligence block.

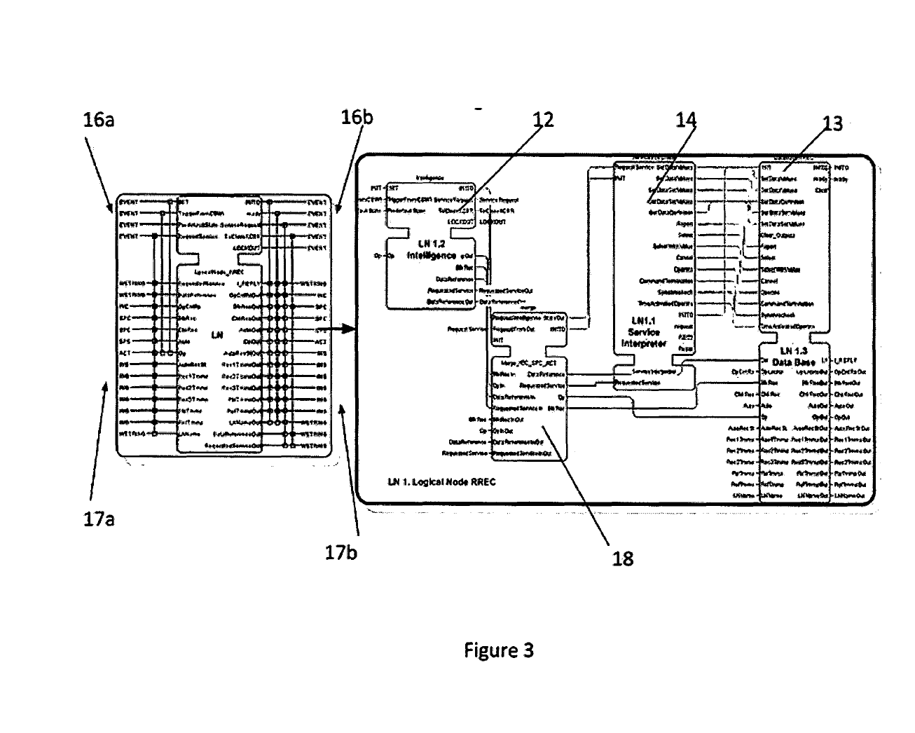

FIG. 3 illustrates connections for a logical node-module 10, with the service-module (not shown in FIG. 3 and shown as 11 in FIG. 2) represented for clarity by only its constituent service-interpreter-module 14 and the database module 13. The logical node-module 10 has external connections defined for the logical node by the standard and the given model for the particular network. The logical node-module 10 has event input connections 16a for receiving standard-compliant events to initiate services and event output connections 16b for events generated by the logical node-module 10 such as when services are performed. The logical node-module 10 also has data input connections 17a and data output connections 17b for receiving standard compliant data objects containing data to be stored or used in operations performed for services or for sending data objects generated by the logical node-module 10 such as by service operations.

FIG. 3 also shows connections for the internal structure of the logical node-module 10. In this example an RREC LN 10 is shown implemented with IEC61499 function blocks. RREC will be recognised by the reader as defined by the IEC61850 standard as a protection related function. The RREC LN 10 performs an autoreclosing function, which is when a circuit breaker is tripped, RREC LN tries to reclose the breaker to check if the trip was caused by a temporary or permanent fault; in case of a permanent fault RREC function (or device) goes to lockout state, and does not try to reclose the breaker.

The connection between service interpreter 14 and database 13 blocks have output event connections of the service interpreter block 14 corresponding one-to-one to the input event connections of the data base block 13. The interpreter block 14 parses requested services and outputs corresponding service-event and the database performs requested services upon receiving the service corresponding event. Data inputs and outputs of the database block 13 interfaces to the external logical nodes (not shown in FIG. 3).

The data connections between the service-interpreter-module 14 and the database-module 13 are unified and the same for all types logical node 8. Here a type is defined by the device or function modelled by the logical node 8 and may be implemented as a type that is supported by a given Intelligent Electronic Device (IED) of a network.

The Intelligence block 12 performs user defined-logic and requests services from its local database block 13, in the same logical node 8, and from other logical nodes 8. To interface its local database block 13 and allow other logical nodes 8 to request service from it, events and data from the service interface block 14 and database block 13 have to be available for the internal intelligence block 12 and for the external interface of a logical node. Thus the data and events of the service and database module are shared between its local intelligence block and external LNs. To enable sharing of the common resources, merge block 18 is introduced in this implementation to multiplex service requests from the local intelligence block 12 and external service requests into single service interface block 14 and single and database block 13.

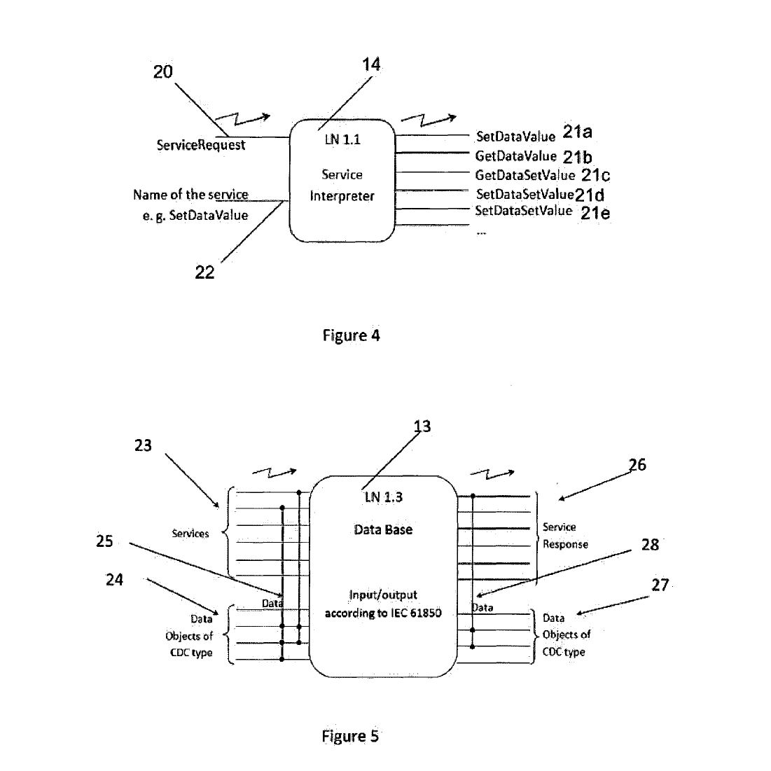

FIG. 4 illustrates operation of the service-interpreter-module 14 in more detail. The service-interpreter-module 14 is responsible for standardised communication between logical nodes using defined service-requests. In this embodiment the service requests are defined by the standard. Service requests and corresponding data from other logical nodes 8 can be received at the connections 20. In this embodiment the corresponding data are data references, data and a requested service. The service-interpreter 14 operates to output service request events at the connections 21. In this embodiment the connections are SetDataValue 21a, GetDataValue21b, GetDataSetValue 21c, SetDataSetValue 21d, and SetDataSetValue 21e. Details of these events are given in the standard used in the IEC61850 standard for this embodiment. The service-interpreter module 14 of this embodiment does not have connections for outputting data, and has only connections 21 for output events. The service interpreter-module 14 illustrated also has a connection 22 for inputs signals or data from the intelligence-module 12. These signals or data may be described as intelligence-service data. The service-interpreter-module 14 operates to receive these intelligence-service data signals in a string data type and to parse them into service-events to allow the intelligence-module 12 to communicate with and affect control of the database-module 13.

In this embodiment the service-interpreter module 14 may be implemented with either a single functional block or multiple functional blocks. It will be apparent to the reader which is preferable in a given instance.

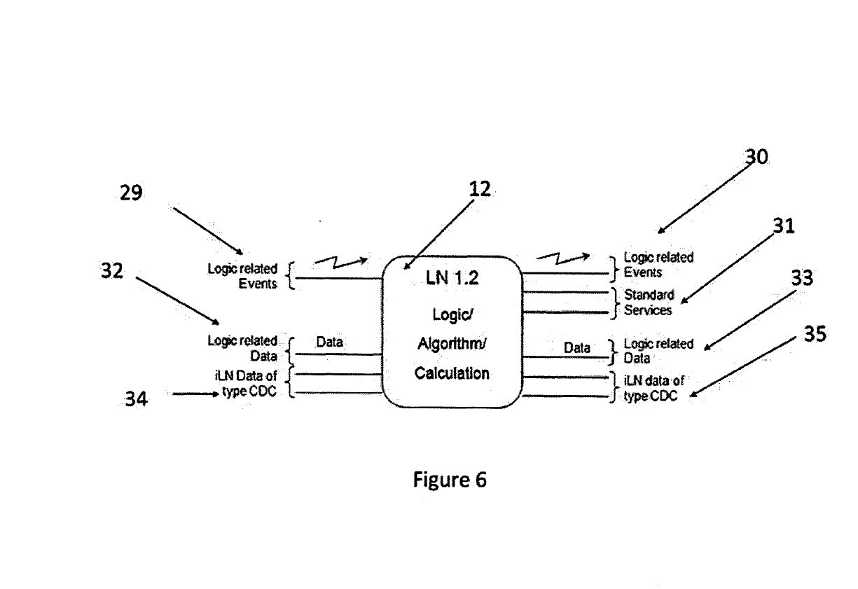

FIG. 5 illustrates the operation of a database-module 13. The database-module 13 represents the information model, or capsule, of the device or function corresponding to the logical node 8. The database operates as a container for all mandatory and optional data objects defined for the particular logical node 8. The reader will understand the database modules 13 of the network 1 to be an information model for the network 1. In this embodiment the information model conforms to the hierarchical structure. The data model stored by the database-module 13 follows, or conforms to, a structure and hierarchy of data objects defined by the Common Data Classes, or CDC s, of the standard.

The database 13 also operates to perform algorithms or operations corresponding to services, defined by the standard for the logical node 8. The database 13 performs these in response to service request-events, also known as service-requests. The response to given service requests is defined by the standard. Input service requests are associated with corresponding data according to functional constraints defined by the standard for the data-objects. In this embodiment the database-module 13 can be implemented using one or more function blocks.

FIG. 5 illustrates connections 23, or inputs, for input service request events, or service requests. Also illustrated in FIG. 5 are connections 24 for input data, in the form of CDC defined data objects. The reader will recognise that the data objects are instantiations of data types defined by the standard. Associations 25 between events and data are also illustrated and lines between event and data connections. FIG. 5 also illustrates connections 26, or outputs, for events in response to service-requests. The reader will recognise these as service responses defined by the standard. Connections 27, or outputs, for data generated in response to service requests are also illustrated along with lines 28 illustrating associations between service-responses and output data. Again the output data is generated in the form of data objects defined by CDC s of the standard.

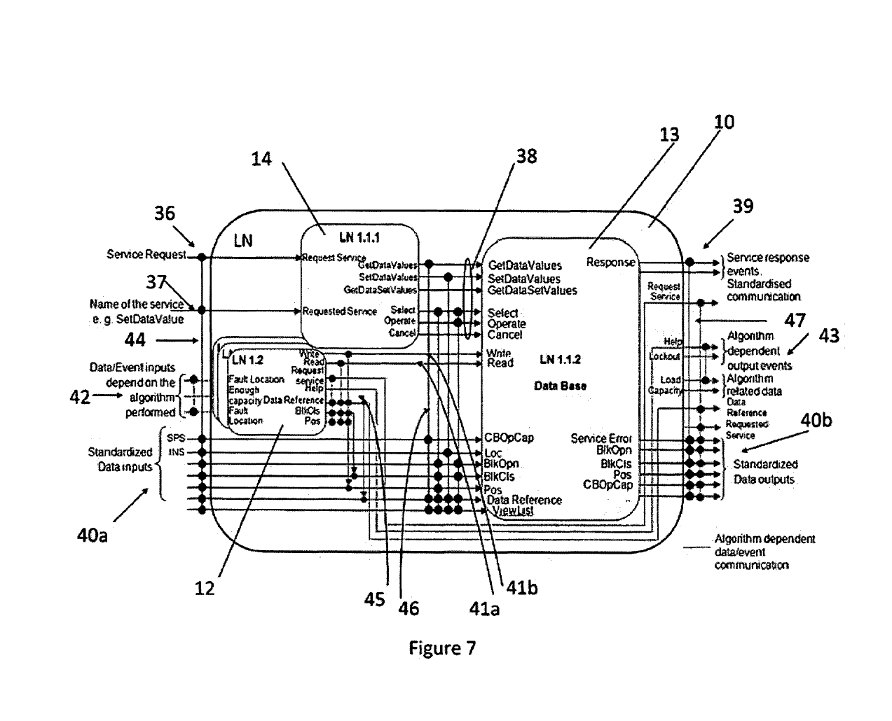

FIG. 6 illustrates in more detail the operation of the intelligence-module 12. The intelligence-module of this embodiment has algorithms which are defined by a user to perform logic, calculations and other algorithms as required for influencing control or even controlling the logical nodes 8, as apparent to the reader. In this embodiment the algorithms implemented by the intelligence-module and the code defining them are not standardised. In this embodiment also the algorithms are defined to participate in applications for agent-based control. The intelligence-module 12 operates to implement behaviour of the logical node 8 as an agent to perform algorithms and calculations. In this embodiment events and data are exchanged with other intelligence-modules 12 within the same logical node-module 10 and/or with intelligence-modules 12 within other logical node-modules 10. The data and event types used by the intelligence-modules 12 do not need to conform to the standard for events and data used by the database 13 for logical nodes 8 to be interoperable according to the information model standard, or IEC61850 standard in this embodiment. Therefore, standardised communications, event-requests and services can be performed by the database-modules 13 while user-defined control applications and corresponding communications can be performed by the intelligence-modules 12. The connections are defined by the user and depend on the algorithms performed by the intelligence-module 12.

The present embodiment uses the service-interpreter-module 14 to request standardised data from the database-module 13 needed for assigned tasks.

As shown in FIG. 6, the intelligence-module 12 has connections 29 and 30 for receiving and sending events used by event driven-algorithms or operations. The intelligence-module 12 has connections 31 for requesting standard services from the database module 13. Connections 32 and 33 allow logic related data to be sent to and received from other intelligence-modules 12. Connections 34 and 35 allow the module 12 to receive and send standardised data objects as defined by the CDC. Typically data exchanged by connections 34 and 35 will be exchanged with a database-module 13.

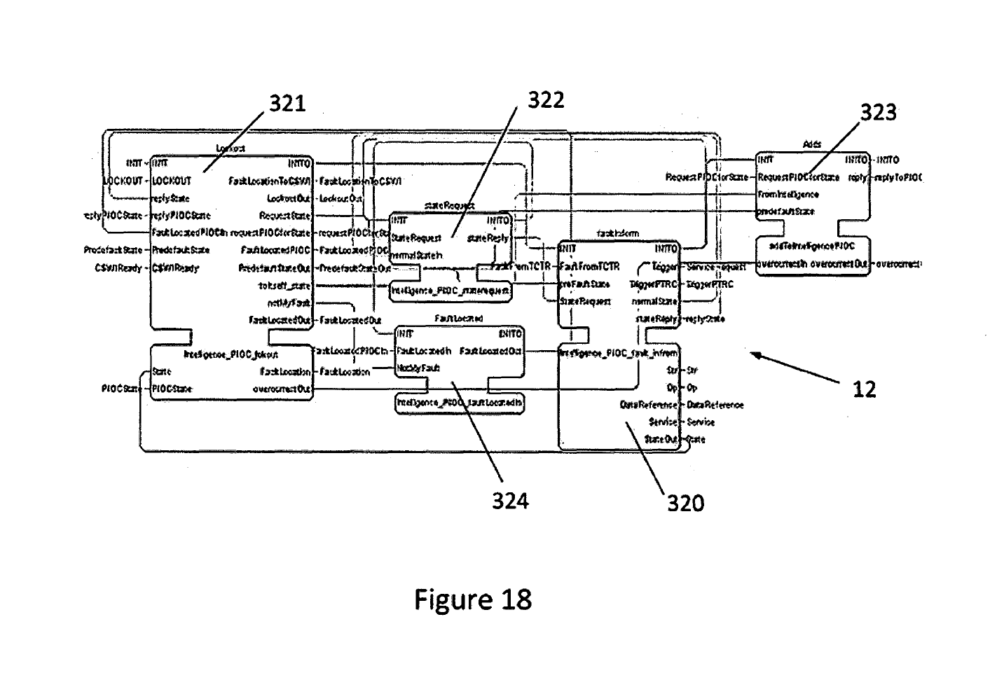

The intelligence-module 12 of this embodiment is implemented using event-driven code capsules which are able to exchange events with each other. Typically, the capsules each have code defining an algorithm and defining a scheduler. This particular embodiment is implemented using functional blocks defined by the IEC61499 standard. These intelligence-modules may comprise intelligence from other intelligence-modules 12 or functional blocks making up these which are performing sub functions. For instance, in PIOC LN intelligence block (FIG. 18), two common sub-functions are lockout and faultinform. The sub-function lockout performs a fault location algorithm after a protection system of the network has announced a lockout state for the system. The sub-function faultinform informs a switch-controller CSWI LN about fault location on a network section of the switch-controller.

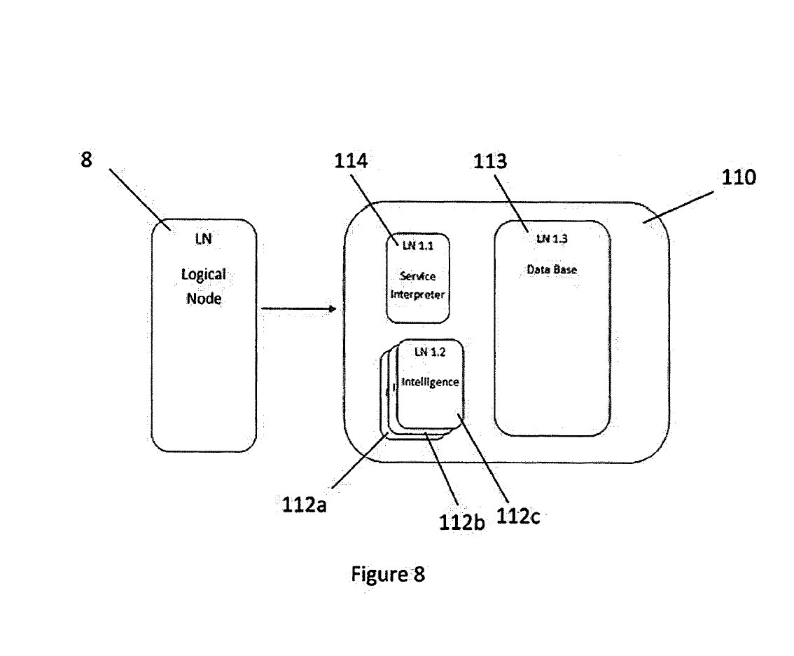

Communication flows within a logical node-module 10 are illustrated in FIG. 7. This embodiment corresponds to the embodiment of FIG. 2 with the difference that it has multiple intelligence-modules 12. Suitable connections for the various modules to support the communication flows illustrated will be apparent to the reader. The events and data objects will also be apparent by reference to the standard. External service requests 36 are received directly by the service-interpreter-module 14 with a requested service name 37. The data value may be represented as a CDC type or more generically of the string type and converted by a database service algorithm to a standardised format. The service-interpreter-module 14 parses the requested service defined by flows 36 and 37 into service-events at flows 38. Here, 38 represents GetDataValues, SetDataValues, GetDataSetValues, Select, Operate, and Cancel. Dependent on receiving the service request events and, the database performs service operations using input data objects 40a and generates service-response-events 39, or service-responses and output data objects 40b. Here, the operation of the database may simply be referred to as performing a service. The service-response-events 39 and data-objects 40 are standardised communications which conform to a response protocol. The intelligence-module 12 is able to use, request or modify data in the database 13 using read and write flows 41a and 41b and special read write services of the database-module 13. In this embodiment the standard does not restrict communication within the device, so the communication within the device can be non-standard in some implementations of various embodiments of the invention. However, communication between the devices needs to conform to the standard. The communication between intelligence block and database 13 can use a standardised service, but it is also possible in some embodiments that intelligence within a logical node module 10 can use write/read services to operate over data in a local database. In this instance “local” means the database 13 in the same logical node module 10. However, to conform to the standard of this embodiment the intelligence-module 12 of another logical node 10 cannot use this write/read service to the database, which is in another logical node. These services (read/write) operate only within a local logical node.

The intelligence-module 12 also receives and generates intelligence dependent communications 42 and 43 dependent on intelligence algorithms.

FIG. 7 also shows associations 44, 45, 46 and 47 between events and corresponding data objects.

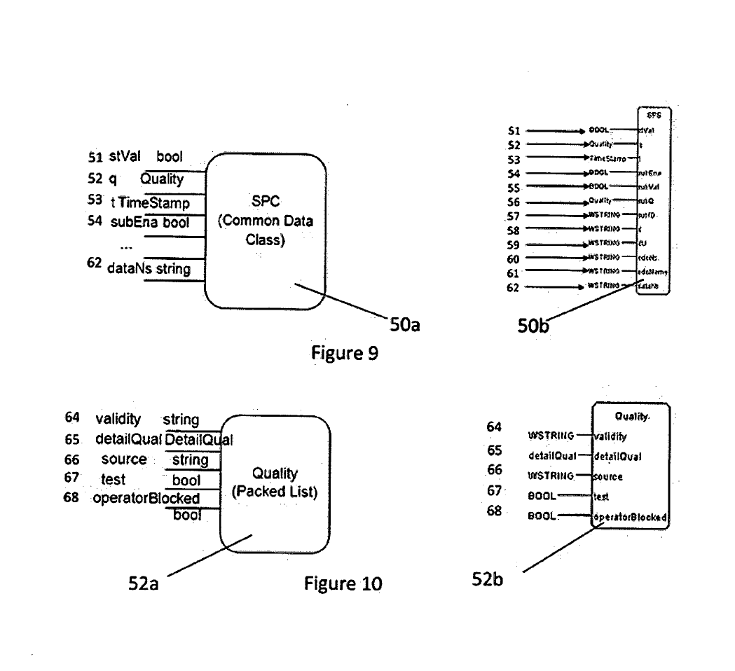

FIG. 8 shows a logical node module 110 of an embodiment which provides an alternative implementation of a logical node 8 to the logical node module 10 shown in FIG. 2. In this embodiment the module 110 is structured with the database-module 113 and service-interpreter-module 114 is not contained in a service interface module 110. Otherwise the functionality is similar to that of the database-module 13 and service-interpreter-module 14 of FIG. 2. In this embodiment also, the logical node-module 10 has multiple intelligence-modules 112a to 112c which each operate to participate either independently or in conjunction with each other depending on the code defined by a user.

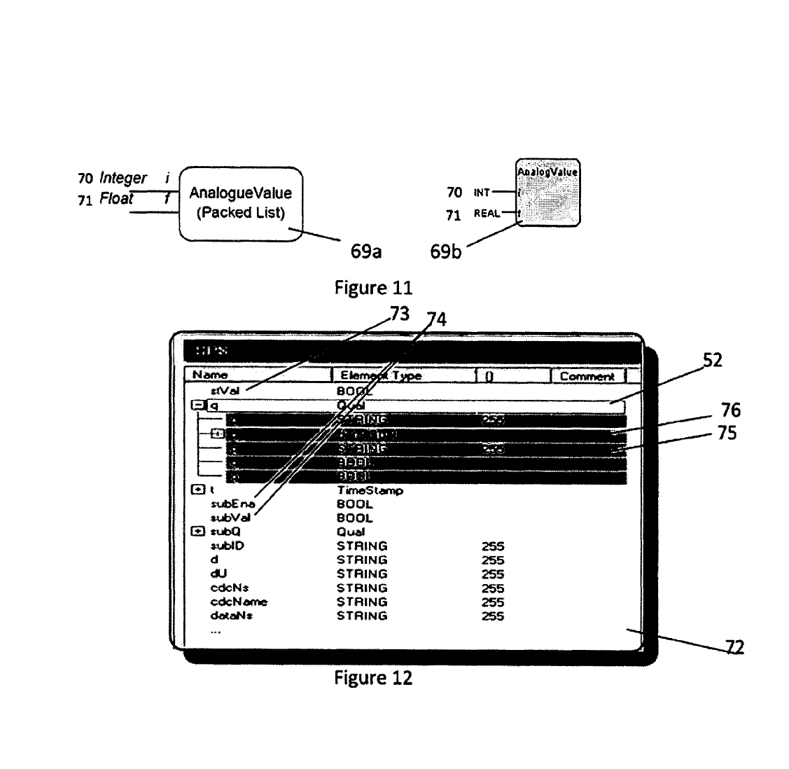

The data structures used by the logical nodes 8 of embodiments of the present invention will now be illustrated with reference to FIGS. 9, 10 and 11 and with reference to IEC 61850-7-3 pages 43 (table 40), 12 (table 2) and 18 (table 4) which gives additional detail and meaning for the data and data attributes referred to in FIGS. 9, 10 and 11. The database-modules 13 use a set of data types referred to as Common Data Types, or Common Data Classes CDC s. These represent data properties of the logical nodes 8, have defined, structured semantics naming conventions and values. These are typically defined for the standard, which is the IEC61850 standard in the case of this embodiment.

In the present embodiment CDC are modelled as User Defined Types (UDT s) as defined in the IEC61499 standard. UDT s allow wrapping of simple types as well as complex types into a single higher-hierarchy complex type. FIG. 9 illustrates a Single Point Status Common Data Class (SPS CDC) 50a. FIG. 9 also shows a UDT 50b implementing a SPS CDC 50. Each CDC has a defined name and a set of CDC attributes. Each attribute has a defined name, a defined type and a specific purpose. Each individual attribute belongs to a set of functional constraints (FC s) that group attributes into categories.

In the example illustrated in FIG. 9, the attributes are st Val 51 q Quality 52, t TimeStamp 53, subEna boolean 54, subVal Boolean 55, subQ Quality, subID WSTRING 56, subID WSTRING 57, d WSTRING 58, dU WSTRING 59, dataNsstring. WSTRING 60, cdcNs WSTRING 61, cdcName WSTRING 62, dataNs WSTRING 63.

FIG. 9 shows variables, such as 51, depicting of the SPS CDC attributes. In this embodiment attributes 52, 53, and 56 are modelled as a UDT of a lower hierarchy which form part of a complex UDT and 51, 54, 55, 57, and 58 to 62 are modelled as simple types.

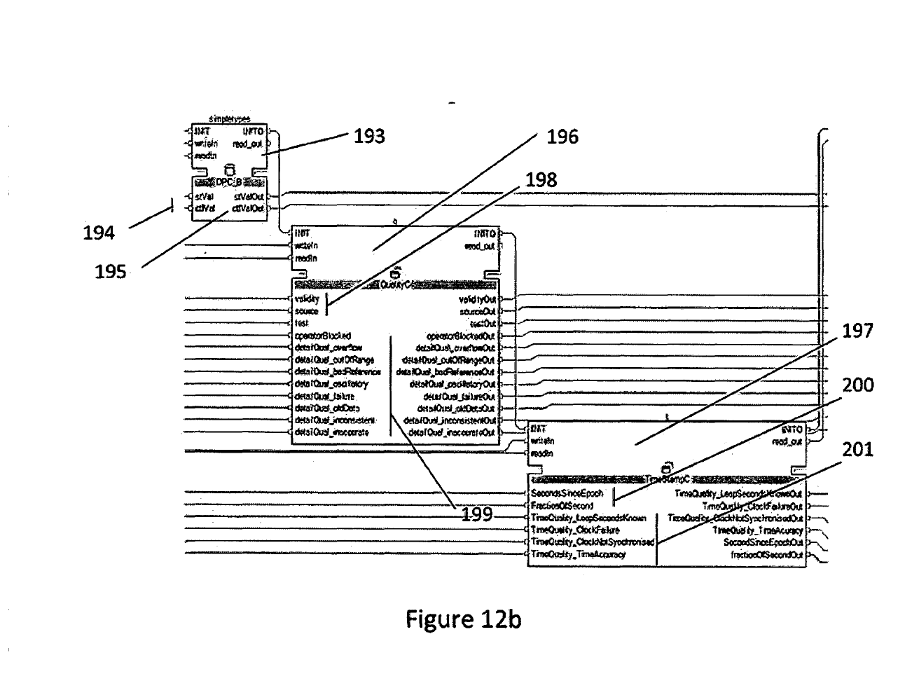

FIG. 10 illustrates an example attribute, Quality 52a, and it's IEC 61499 implementation 52b. As illustrated the attribute Quality 52, has variables validity string 64, detailQual DetailQual65, source string 66, test bool 67, operatorBlocked bool 68. Illustrated in FIG. 10 a concept 52b implementing the Quality 52a as an UDT with corresponding variables.

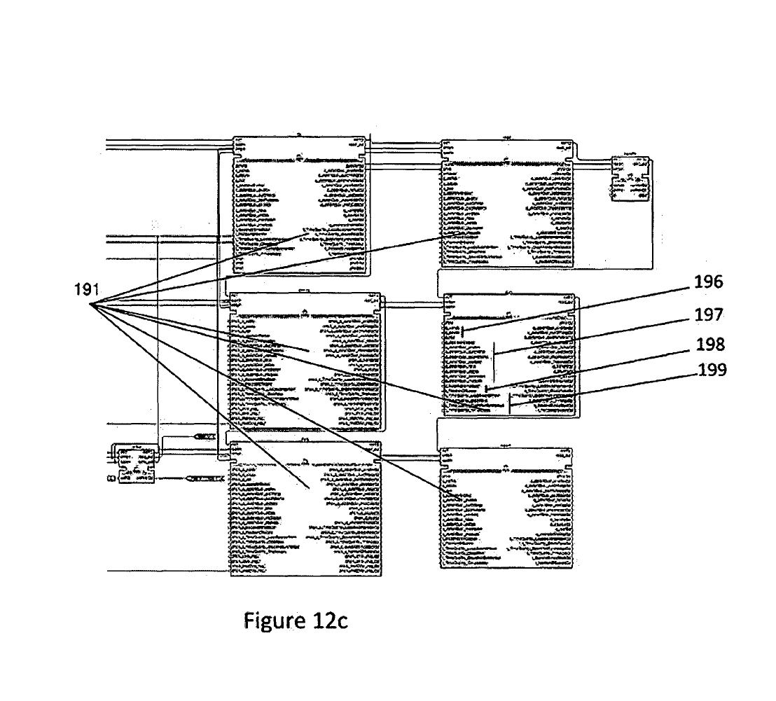

FIG. 11 illustrates a packed-list 69a, which is the lowest hierarchy complex type and does not contain variables of complex types. All variables in the packed-list are simple types such as the Integer i 70 and the float f 71 of the AnalogValue packed list 69a. The IEC 61499 UDT 69b, implementing the AnalogValue 69 has corresponding variables INT i 70 and REAL f 71.

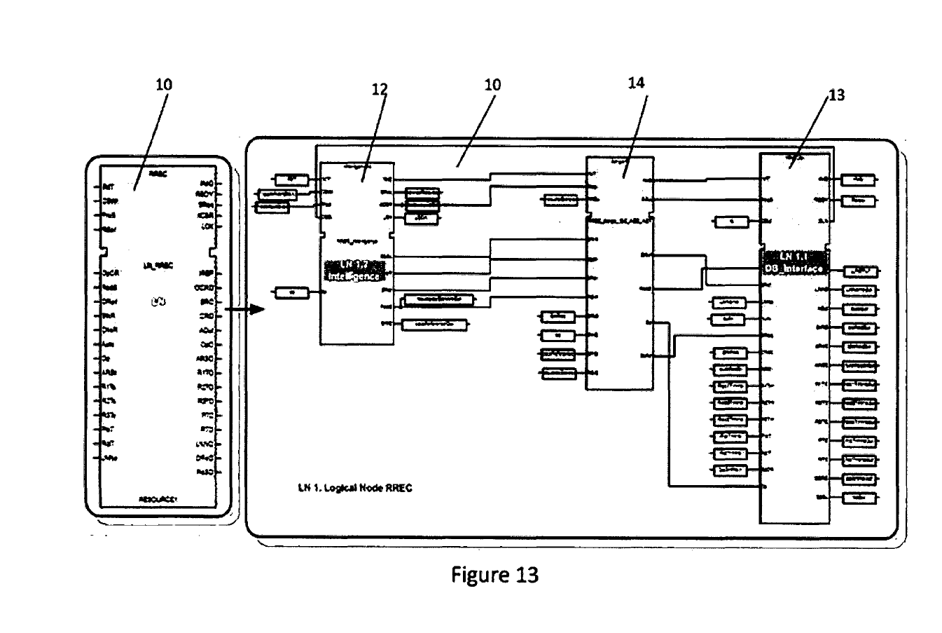

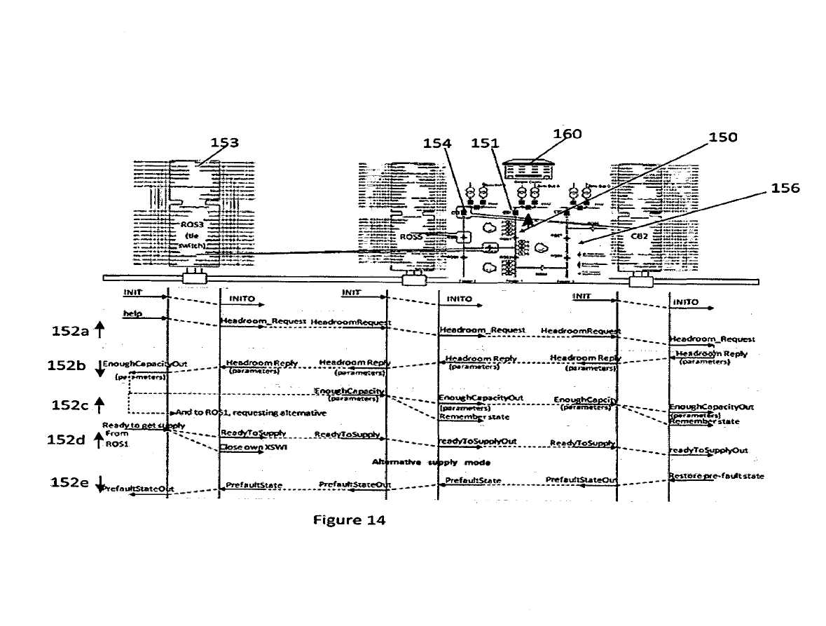

An example of an implementation of a logical node 10 of an embodiment of the invention using nxtControl and isaGraf tools is illustrated with reference to FIGS. 12 and 13 and in reference to IEC 61850-7-3 page 26 Table 19 and IEC 61850-7-4 page 86 which details semantics and describes data and data attributes depicted in FIGS. 12 and 13.

On the figure an example of UDT implementation of CDC is shown. UDT 72, implementing a Single Point Status SPS CDC, is the highest level of data hierarchy. SPS type contains data attributes 73 of simple types stVal of type BOOL, subEna of type BOOL, subVal of type BOOL74. Also it contains data attributes 52 of complex types—q of type Quality 52. This is the next stage of hierarchy. Data attribute q consists of simple 75 (String) and complex (detailQual) data 76. detailQual 76 representing details of quality of this data attribute is a complex data type—packed list. As known to the reader, a packed list is the lowest level of data hierarchy and consists of simple types only.

FIG. 12a, shows an example implementation of Double Point Control DPC CDC in nxtControl is shown. As the reader will be aware, nxtControl does not currently support UDTs. Details of the CDC attributes are given in IEC 61850-7-3 page 44 table 41. In this embodiment UDTs are modelled as basic function blocks 192 with read and write services and data attributes 194-199 flattened out, because the convenience of using a UDT is not available.

As shown in FIG. 12b, CDCs 192 are made of basic function block193, representing data attributes of simple types194, and containing variables 195 of simple data types 194; and composite blocks 196 and 197 representing data attributes of complex data types and containing data of simple types 198 and 200 and data of complex types 199 and 201. As the reader is aware, more detail is available in IEC 61850-7-3 p 12 and IEC 61850-7-2 p 26, table 7. IEC 61850-7-2. In FIG. 12c the database 13 of a Protection Differential function PDIF Logical Node 8, is a composite block containing data objects of the CDC represented as composite functional blocks 191. As the reader is aware IEC 61850-7-4 page 61-62 gives data and data attributes of this Protection Differential function PDIF logical node 8.

FIG. 13 shows the implementation of the logical node-module 10. In this example the logical node 8 is RREC using ISaGRAF tool.

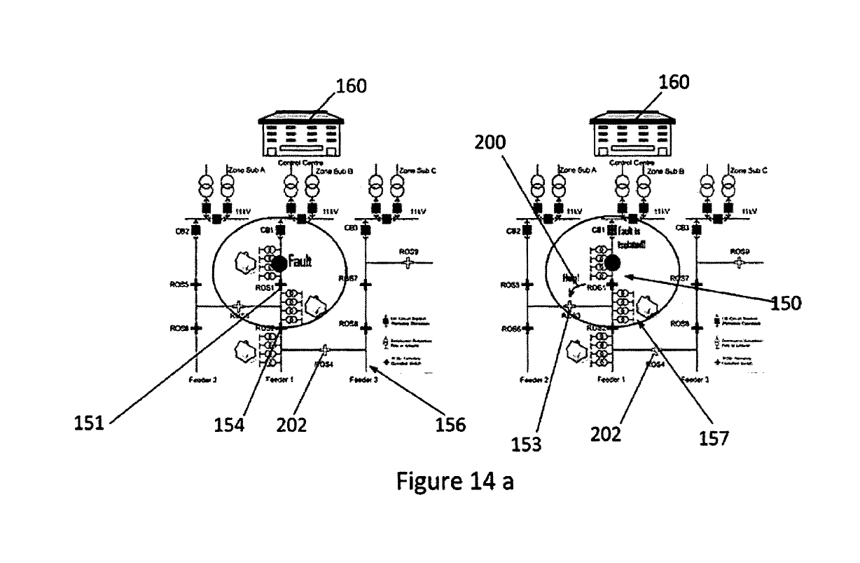

An example of communication between logical nodes 8 of an embodiment of the present invention is illustrated by FIGS. 14 and 14a in a protection scenario involving fault location, isolation and supply restoration. In this example, agent-based control of a feeder, known to the reader, in the event of a fault is demonstrated. Also demonstrated are multi-agent applications applying self healing and self awareness features, with standardised communication between agents, as logical node-modules 10, and standardised data structure for logical node-modules 10 to assure interoperability. Legacy logical nodes (not shown) that support IEC61850 can communicate with agent logical node-modules 10 and participate in control. Also demonstrated are negotiation operations between agent logical node-modules 10 looking for alternative supplies. Here an intelligence module 12, or a sub-module (not shown) of same includes algorithms and connections that allow it to be an agent of a multi-agent operation distributed over the set of logical nodes 10 of the network.

Collaboration between logical node-modules 10 starts when a fault occurs on one of the feeders 150, feeder 1, at the position of circuit-breaker 1, 151. Logical node 8 implementing the protection functions trip CB 1 151, reclose it and, if the fault is permanent, and auto-closing function will set to lock-out. The arrows 152 depict upstream (up the page) and downstream (down the page) communication flows respectively. Once the fault has been located by Protection Instantaneous Over Current PIOC (LN for overcurrent protection, relay), and Control SWItch CSWIs (switch controller LN) are informed of the fault location on the section 150, section1, of CB1. The CSWIs that do not have a fault on their respective sections send help signals to tie switches to request searches for alternative supplies. For example the ROS 1 sends a help 200 as shown in FIG. 14a signal to the tie switch ROS3 153, and ROS2 201 sends a help to tie switch ROS4 202. The tie switch ROS3 153 propagates a headroom request signal to upstream switches 154 on the feeder2 154. The switches 154 reply with headroom capacity and the tie switch 153 ROS3 determines whether there is sufficient capacity to supply the requesting section, 150. In the case of insufficient headroom capacity, the switches return to a normal state and the alternative supply will not be restored. In the case of sufficient headroom capacity a CSWI on a non-faulted feeder transfers to an alternative supply state and the alternative power is restored to the non faulty section 157 of the faulty feeder 151. The power will flow from feeder 2 154 though the tie switch 153 t on the section 157. Once the fault has been cleared and the signal to restore the pre-fault state has been received from the control centre 160, all three feeders (feeder 1, 2 and 3) 151, 154 and 156 return to their pre-fault configurations.

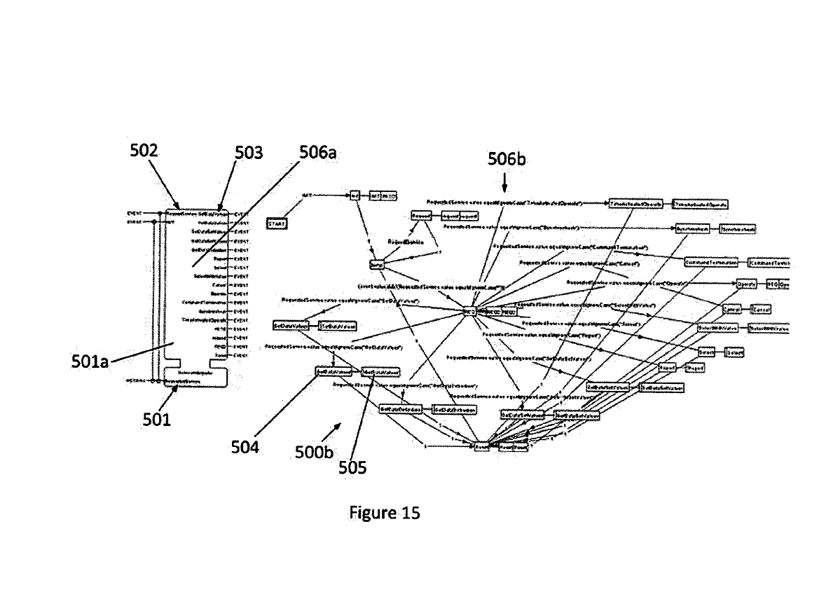

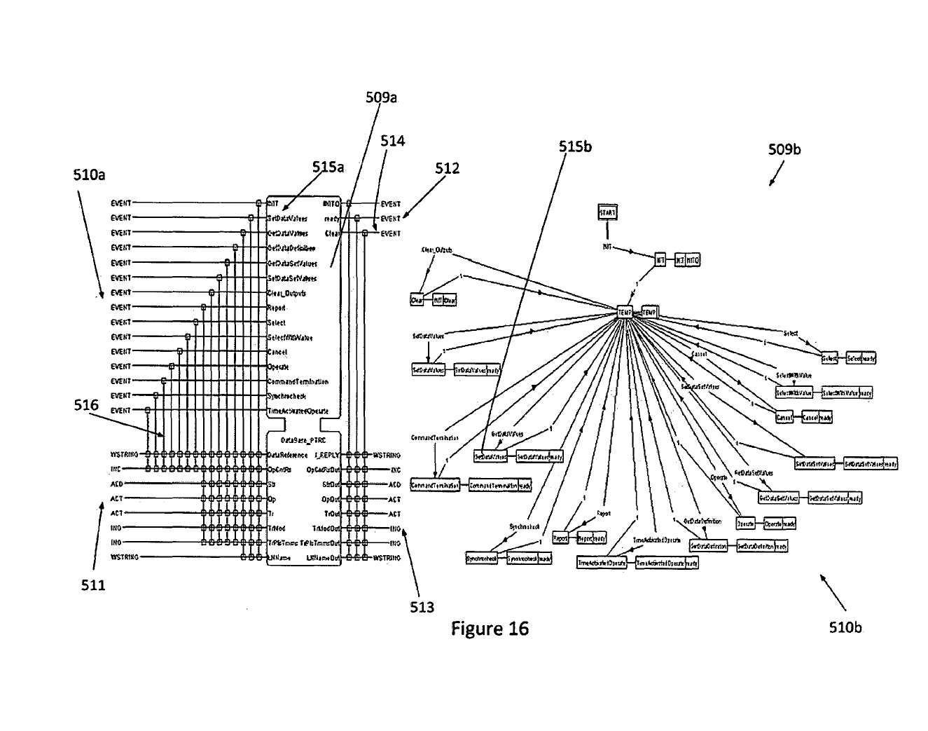

As the reader will be aware, a full list of services described in FIG. 15 and FIG. 16 are given in IEC 61850-7-2.

An exemplary service-interpreter-module 14 implemented as a function block 500a and a corresponding state-machine 500b is illustrated in FIG. 15. On the right side the interface of the function block is shown. Requested service is given by Requested Service 501 as string, for instance GetDataValues. With the event RequestService 502. The ServiceInterpreter starts parsing given string and emits corresponding requested service output event. In this case it is GetDataValues 503 event. For each service 501 there is corresponding state 506 b with the corresponding output event assigned 506 a. For example, for the GetDataValues there is a state GetDataValues 504 with the output event assigned GetDataValues 505. The reader will recognise that events and states are indicated generally as the state diagram and interface will be dictated by the services supported by a given example of logical node 8. Thus, the output event 503 corresponds to the requested service 501.

An exemplary database-module 13 and a corresponding state-machine are illustrated in FIG. 16. A state diagram 509 depicts the interface of the function block 509a. The events 510a and 510b correspond to IEC61850 services in this embodiment. These services 510a and 510b are connections, or outputs, of a ServiceInterpreter module 14. Service-events 510a are associated, as depicted by associations 516, with the corresponding data 511 they are allowed to operate over as defined by the standard. The outputs 512, 513 are the result of the executing service requests according to the standard. The Clear 514 output event is to clear values of the output data. The algorithm on the left demonstrates the execution chart: database block executes an algorithm corresponding to the requested service (incoming service-events). For each service-event 510a there is corresponding state 510 b. For instance, GetDataValues service 515 a will have a corresponding state 515 b.

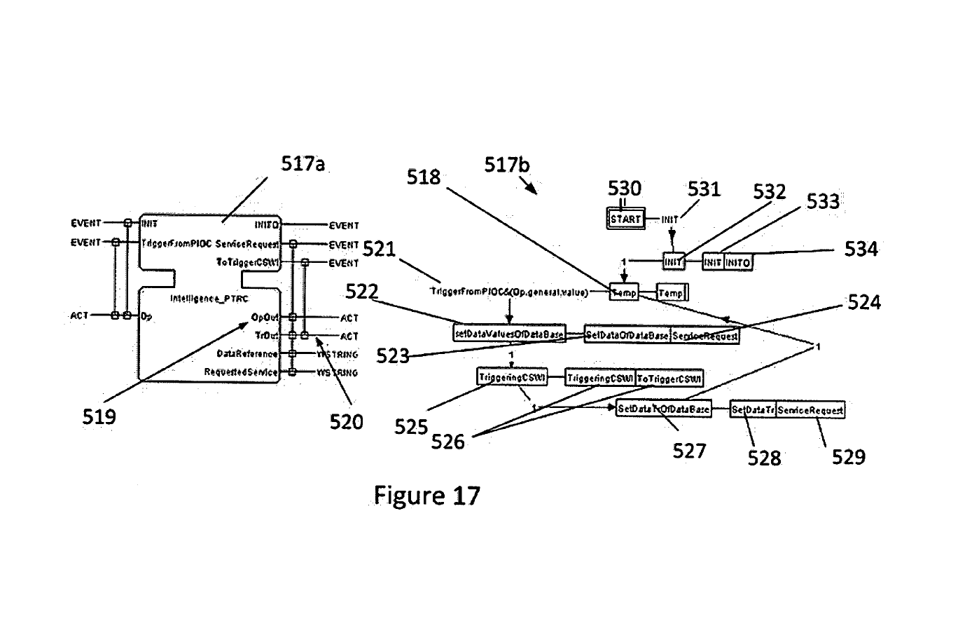

An exemplary intelligence-module 12, in this example a function Block 517a, and a corresponding state-machine 517b is illustrated in FIG. 17. PTRC is a protection trip conditioning logical node 8. As it is shown on the state machine 517b, the block is in Temp state 518, waiting for one of the protection element blocks (overcurrent relay, differential protection, and other blocks known to the reader.) and will detect a fault and will signal to PTRC to operate: variable Op 519 with the corresponding event TriggerFromPIOC 520. This corresponds to the condition 521. Intelligence block PTRC changes Op value in the database in state 522 performing algorithm 523 and outputting output event 524. Then it in state 525 performing algorithm 526 triggers switch controller (CSWI) to trip circuit breaker. And in this example implementation of PTRC, intelligence block changes value Op in database to the original value in state 527 performing algorithm 528 and emitting output event 529. Then the PTRC returns back to the waiting state 518. State 530 is the initial state of FBs. With arrival of INIT event 531, intelligence block moves to state 532 to run initialising algorithm 533 and set all necessary data to initial values. When INIT algorithm 533 is completed, it emits INITO output event 534.

A more detailed example of a Protection for Instantaneous Overcurrent (PIOC) intelligence block 12 is illustrated in FIG. 18. The PIOC operates to perform a fault location algorithm and is implemented in this example using IEC61499 Function Blocks. In this case, PIOC intelligence block 212 performs a protection function and fault location algorithm. Correspondingly the intelligence block 12 has two major FBs: FaultInform 320 and Lockout 321 PIOC intelligence and 3 auxiliary FB s, namely StateRequest 322, FaultInform 323. and FaultLocated 324. The FaultInform FB, intelligence registers the fault information from connected TCTR (current transformer) (not shown) and triggers the PTRC LN (not shown). As the TCTR detects the fault it informs PIOC intelligence 212, where FaultInform block triggers PTRC and changes PIOC state from normal to fault. Function of Lockout 321 is to collaborate with other PIOC LNs and locate the fault. The rest 3 auxiliary FBs run in parallel and perform following function: FaultLocated 324 catches fault location information from other PIOC LNs; Adds 323 responds to other PIOCs request of its current state (fault or normal); StateRequest 322 is an auxiliary FB serving a buffer role for the internal operation only.

The algorithm for location of the fault starts once intelligence block 12 gets LOCKOUT input event. Once the intelligence block 12 starts locating the fault: it sends the state request to stateRequest for its own state identified in the 323 FaultInform block. Once the Lockout block 321 block gets stateReply it emits state to notify the Adds block 323 about the PIOC state after lockout. In the case where the PIOC state is normal then PIOC 312 moves to notMyFault state and waits for the FaultLocatedPIOC event, then it moves into faultLocated state and propagates FaultLocated event. If the PIOC state is fault PIOC moves to MyFault state and issues FaultLocatedPIOC and transfers to faultLocated state. In this state PIOC 12 (Lockout FB 12) informs corresponding CSWI about the fault location. Either PredefaultState or CSWIReady events will make PIOC 12 transfer to the normal state. CSWIReady implies that corresponding CSWI is ready to get an alternative supply, and PIOC has to come back to normal state to react on fault current as the supply is restored.

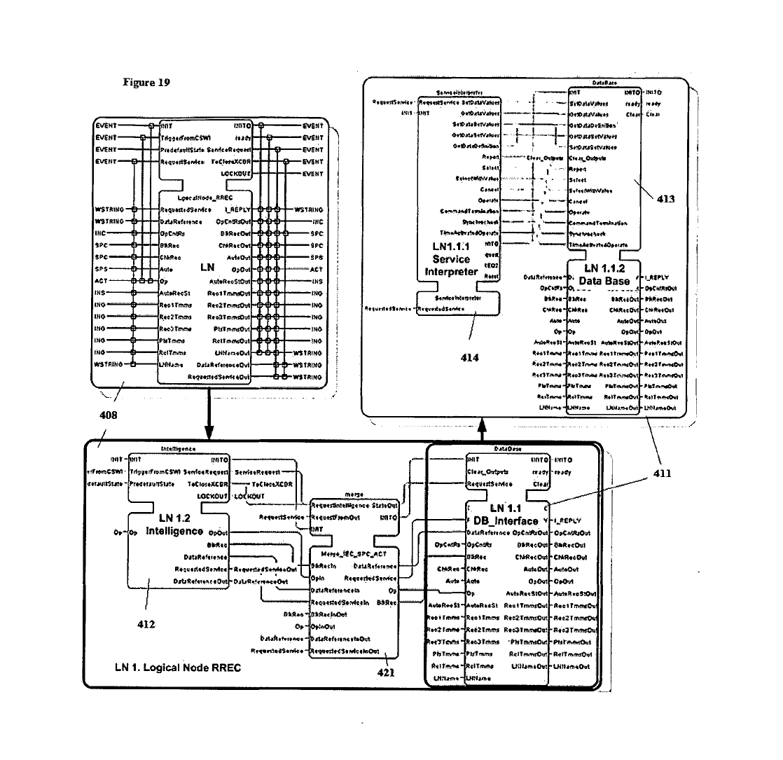

An example of a Function Block implementation of a Logical Node 8 is shown in FIG. 19. In this example a RREC LN 408, autoreclosing function. RREC 408 consists of—intelligence block 412, service interface block 411, or database interface. The auxiliary FB Merge 421 is introduced here to merge (multiplex) two data inputs into corresponding inputs of service Interface 411. The service interface 411 is a complex FB, and consists of server Interpreter block 414, and DataBase 413.

Further and additional embodiments of aspects of the invention will now be described. In some embodiments the intelligence-module is formed of sub-modules which each perform sub-functions of the functions performed by the intelligence block. In some embodiments modules described herein are implemented as source code modules by various means known to the reader. In one example, a module may be defined by a namespace. In other embodiments the modules described herein may be implemented as object code for a computer, or processor of an Intelligent Electronic Device. In other embodiments modules may be implemented as firmware or as hardware description language, such as VHDL, or as hardware such as known to the reader and including Field Programmable Gate Arrays (FPGA s) or Application Specific Integrated Circuits (ASIC s). The modules, or blocks, described herein with reference to given embodiments contain code which performs operations described when executed. Depending on the implementation of the modules various embodiments of the invention implement connections for data objects or events include argument variables, software methods such as set or get methods, interface classes, XML or other data files, physical connections or other known connections for data objects, or events.

The code of various embodiments may be stored on computer or processor readable media including EEPROM, Flash Memory, other volatile or non-volatile memory, magnetic or optical storage media, or other known storage media. For some embodiments the code may be carried using carrier media including electronic, or optical carrier signals, or communication protocols including TCP/IP, FTP, EtherNet, or other known carrier media.

In reference to some embodiments, the term module describes a functional unit which may represent source or object code or even hardware. In some embodiments modules are function blocks. In some embodiments the function blocks are IEC61499 compliant function blocks or blocks which have one or more characteristics of the IEC61499. In other examples the modules are implemented as source code functions or classes which are defined by the user to provide connections, outputs and functionality described with reference to modules. In some embodiments the modules described in reference to the embodiments above are combined or divided into other modules as known to the reader to be appropriate for given applications or implementations. In some embodiments of the present invention software modules are replaced or interchanged with hardware modules or firmware modules. In some embodiments the functional units represented in the description as modules are provided using dedicated hardware, such as FPGA s. In some embodiments the software modules for a number of logical nodes 8 may be executed on one processor.

In some embodiments all logical nodes 8 forming a logical device may be executed on single processor co-located or otherwise associated with a physical device. Other embodiments may involve execution of an arbitrary number of logical nodes 8 for a network on one processor. For other embodiments one or more logical node-modules may be implemented on a dedicated processor associated with an intelligent electronic device which is provisioned to support given types of logical node as defined by a standard.

Some embodiments provide a compiler or Application Programming Interface (API), or Software Development Kit (SDK) which allows a user to defined code for the intelligence-modules defines logical node-modules but defines the rest of the logical node-module. In some embodiments, code developed or compiled may conform to a standard for distributed applications, such as the IEC61499 standard. In other embodiments code may conform to the IEC61131 standard. Other embodiments may use function blocks of both the IEC61499 and IEC61131 standards. In some embodiments the entire logical node module is implemented using function blocks, but in alternative embodiments only some of the modules within the logical node module, such as the intelligence-module is implemented as function blocks.

Embodiments of the present invention provide a power distribution network using a data model adapted to facilitate centralised monitoring and/or automation to perform protection functions in response to faults on the network, the data model defining logical node software modules and defining services to be performed by the logical nodes, defining events to request services and defining data types associated with the services, the devices having associated processors which implement logical devices being analogs of the physical devices the logical devices comprising sets of logical node modules which each include:

a service-module which performs the services in response to the events and stores data according to the data types; and
one or more intelligence-modules which communicate with the intelligence-modules of other logical node modules and communicate with service-modules and adapted to perform functions to facilitate data collection from points on the network and/or bartering operations to determine a configuration for the network in response to the detection of faults.

In some embodiments the functions comprise part of a multi-agent operation. Some embodiments allow a network that uses a data model that defines a hierarchy for centralised monitoring and protection automation or control for reconfiguration by an operator to implement intelligence that uses data and/or operations from multiple points around a network or which uses multi-agent processes involving agents distributed over the network.

Embodiments of the present invention implement control of physical devices by making available to these devices data defining the logical node and the identifying the state of the logical node using data base modules or service-modules. Various embodiments use any means for making the data available known to the reader.

In embodiments of the present invention the intelligence-module enhances a power distribution system, or transmission or other electricity powers systems, or a network that has centralised monitoring and automation for network and/or reconfiguration and assured interoperability with agent-based control. Some embodiments allow the system or network to be self-aware self-healing, alive and interactive.

In some embodiments the service-interpreter assures interoperability through the use of standardised data structures and/or defined communication mechanisms and the intelligence-module provides user-defined algorithms for flexible and self-configurable agent-based control of logical nodes and equipment associated with them.

The processor of embodiments of the invention is operable to control the behaviour of the group according to event-driven algorithms distributed across the network and the devices can be controlled with assured interoperability as part of a network of devices.

In embodiments of the invention the behaviour of the group can be controlled by code defined by given users of the processor by providing code only for the intelligence-module with assured interoperability of logical devices and/or nodes in the network.

In the preceding description and the following claims the word “comprise” or equivalent variations thereof is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

What we claim is:

1. A network including a set of network devices and a set of processors operable to control and/or monitor the operation of the set of devices by executing code defining a data-model for the network, the data-model comprising a set of logical-nodes encapsulating network functions and/or network devices, the data-model being composed of logical-nodes of defined types conforming to a design standard, the design standard defining allowed interconnections of logical-nodes for centralised monitoring and/or control of the set of devices, wherein the data-model is structured in a hierarchy for centralised control and/or monitoring, wherein for each logical-node the code defines:
at least one service-module having a set of connections for service-events and operable to store and/or update service-data objects in response to service-events, the service-module having a dedicated connection for each type of service-event to be received by the service-module, wherein the service-events and service-data objects conform to types defined for the logical-node by the design standard, the design standard defining the type of service-events which the service-module is allowed to receive;
at least one intelligence-module having connections to exchange intelligence-events with other intelligence-modules and operable to participate in intelligence-operations distributed across multiple intelligence-modules and operable to generate service-intelligence data defining service-events capable of reception by the service-module or service-modules of the type or types defined for the logical-node by the design standard,
whereby service-events are used to control and/or monitor the operation of the set of devices and whereby one or more of the service-events are defined by intelligence-operations.

2. A network as claimed in claim 1 wherein the design standard defines a multi-layer data-model with interconnected layers for physical functions, network protection for physical functions, and central automation and human interfacing, whereby a central controller and human interface are adapted to assert control over the network, and
said at least one intelligence module implements an agent of a multi-agent distributed intelligence application to participate in intelligence-operations to influence control of the network.

3. A network as claimed in claim 1 wherein for each logical-node the code defines an interpreter-module having one or more connections for the communication of service-intelligence data and for service-events, each interpreter-module being operable to parse service-intelligence data to service-events.

4. A network including a set of network devices and a set of processors operable to control and/or monitor the operation of the set of devices by executing code defining a data-model for the network, the data-model comprising a set of logical-nodes encapsulating network functions and/or network devices, wherein the data-model is structured in a hierarchy for centralised control and/or monitoring, wherein for each logical-node the code defines:
at least one service-module having a set of connections for service-events and operable to store and/or update service-data objects in response to service-events, wherein the service-events and service-data objects conform to types defined for the logical-node by a design standard;
at least one intelligence-module having connections to exchange intelligence-events with other intelligence-modules and operable to participate in intelligence-operations distributed across multiple intelligence-modules and operable to generate service-intelligence data defining service-events for one or more service-modules,
whereby service-events are used to control and/or monitor the operation of the set of devices and whereby one or more of the service-events are defined by intelligence-operations.

5. A network as claimed in claim 4 wherein for each logical-node the code defines an interpreter-module having one or more connections for the communication of service-intelligence data and for service-events, each interpreter-module being operable to parse service-intelligence data to service-events.

6. A network as claimed in claim 4 wherein the devices in the network are connected in a hierarchy so as to provide centralised monitoring and/or control of the network.

7. A network as claimed in claim 4 wherein the data-model includes groups of logic-nodes structured to form a logical device as defined by the design standard.

8. A network as claimed in claim 4 wherein each processor is associated with a device and operable to control the associated device dependent on data stored by a service-module.

9. A network as claimed in claim 4 wherein a device may be a logical device as defined by the design standard or a physical device.

10. A network as claimed in claim 4 wherein the data-model is defined by the design standard.

11. A network as claimed in claim 10 wherein the design standard is IEC61850.

12. A network as claimed in claim 4 wherein the code defining each logical-node or module includes an event driven algorithm and a scheduler.

13. A network as claimed in claim 4 wherein one or more modules is a composite module formed from other modules.

14. A network as claimed in claim 4 wherein a module is provided by IEC61499 or IEC61131 standard compliant function blocks.

15. A network as claimed in claim 4 wherein the network is a power distribution substation.

16. A network as claimed in claim 4 wherein intelligence-operations include protection and/or monitoring processes for the network.

17. A network as claimed in 4 wherein an intelligence-module implements an agent of a multi-agent distributed intelligence application to participate in intelligence-operations.

18. A network as claimed in claim 17 wherein intelligence-operations include bartering algorithms involving bartering between agents associated with two or more logical nodes or two or more logical devices

19. A network of devices including a set of processors operable to execute control code to control the devices, the code comprising a set of node-modules each encapsulating a node of a data-model defined for the network, each node-module comprising:
at least one service-module having connections to exchange service-events and service-data objects with other node-modules, the service-events and service-data objects conforming to a design standard, the service-module having one or more algorithms to store and/or update data for the node-module dependent on service-events and dependent on service-data objects received at the connections;
at least one intelligence-module having connections to exchange intelligence-events and intelligence-data objects with other intelligence-modules, having one or more algorithms to participate in intelligence-operations distributed across a number of intelligence-modules, and one or more algorithms to generate service-intelligence data defining service-events and service-data;
at least one interpreter having connections to receive service-intelligence data and generate service-events and service-data objects which conform to the standard.

20. A network as claimed in claim 19 wherein the devices in the network are connected in a hierarchy so as to provide centralised monitoring and/or control of the network

21. A network as claimed in claim 19 wherein the data-model includes groups of logical-nodes structured to form a logical device.

22. A network as claimed in claim 19 wherein an intelligence module implements an agent of a multi-agent distributed intelligence application to participate in intelligence operations.

23. A network as claimed in claim 22 wherein intelligence-operations include bartering algorithms involving bartering between agents associated with two or more logical nodes or two or more logical devices

24. A carrier medium carrying code defining a code module which encapsulates a node-module of a data-model defined for a network, the code module comprises:
a service-module arranged to make a set of connections to exchange service-events and service-data objects with other node-modules, the service-events and service-data objects conforming to a design standard, the node-module having one or more algorithms to store and/or update data for the node-module dependent on service-events and service-data objects received at the connections;
an intelligence-module arranged to make to connections exchange intelligence-events and intelligence-data objects with other intelligence modules, said intelligence-module having one or more algorithms to participate in intelligence-operations distributed across a number of intelligence modules, and one or more algorithms to generate service-intelligence data defining service-events and service-data;
whereby service-events are used to control and/or monitor the operation of the set of devices and whereby one or more of the service-events are defined by intelligence-operations.

25. A processor with data memory and operating memory, said data memory storing a code module which encapsulates a node-module of a data-model defined for a network, the code module comprises:
at least one service-module configured to make connections for the communication of service-events and operable to store and/or update service-data objects in response to service-events, wherein the service-events and service-data objects conform to types defined for the logical-node by a design standard;
at least one intelligence-module configured to make connections to exchange intelligence-events with other intelligence-modules and to operable to participate in intelligence-operations distributed across multiple intelligence-modules and operable to generate service-intelligence data defining service-events for one or more service-modules;
at least one interpreter having configured to make connections to receive service-intelligence data and generate service-events and service-data objects which conform to the standard.

26. An integrated development environment arranged to assemble a code module which encapsulates a node-module of a data-model defined for a network, where the code module comprises:
at least one service-module configured to make connections for the communication of service-events and operable to store and/or update service-data objects in response to service-events, wherein the service-events and service-data objects conform to types defined for the logical-node by a design standard;
at least one intelligence-module configured to make connections to exchange intelligence-events with other intelligence-modules and to operable to participate in intelligence-operations distributed across multiple intelligence-modules and operable to generate service-intelligence data defining service-events for one or more service-modules;
at least one interpreter having configured to make connections to receive service-intelligence data and generate service-events and service-data objects which conform to the standard,
said integrated development environment including a library of code elements available for selection by a user for assembly into a code module.
